(19) United States
(12) Patent Application Publication
(10) Pub. No.: US 2025/0336139 A1
(43) Pub. Date: Oct. 30, 2025

(54) MODEL SEAM REPAIRING

(71) Applicant: Tencent Technology (Shenzhen) Company Limited, Shenzhen (CN)

(72) Inventors: Zhigang CAI, Shenzhen (CN); Yuanheng LI, Shenzhen (CN)

(73) Assignee: Tencent Technology (Shenzhen) Company Limited, Shenzhen (CN)

(21) Appl. No.: 19/262,085

(22) Filed: Jul. 7, 2025

Related U.S. Application Data
(63) Continuation of application No. PCT/CN2024/083202, filed on Mar. 22, 2024.

(30) Foreign Application Priority Data
May 30, 2023 (CN) 202310626315.6

(51) Int. Cl. G06T 15/04; G06T 5/70; G06T 15/06; G06T 15/50; G06V 10/60

(52) U.S. Cl. CPC G06T 15/04; G06T 5/70; G06T 15/06; G06T 15/506; G06V 10/60

(57) ABSTRACT

A ray emission region perpendicular to a normal direction of a sampled texel in a first mesh patch of a first initial three-dimensional mesh model in a three-dimensional virtual scene is constructed. One or more rays that start in the ray emission region and extend in an opposite direction of the normal direction of the sampled texel are constructed. One or more candidate texels that intersect with the one or more rays are determined. When the one or more candidate texels include at least one spatially adjacent texel of the sampled texel, the sampled texel is determined as a first seam texel. From the at least one spatially adjacent texel, a second seam texel having a seam adjacency relationship with the first seam texel is determined. At least a seam repair of the first seam texel and the second seam texel is performed to obtain a target three-dimensional mesh model.

### RELATED APPLICATIONS

The present application is a continuation of International Application No. PCT/CN2024/083202, filed on Mar. 22, 2024, which claims priority to Chinese Patent Application No. 202310626315.6, filed on May 30, 2023. The entire disclosures of the prior applications are hereby incorporated by reference.

### FIELD OF THE TECHNOLOGY

This application relates to the field of illumination rendering technologies, including a model seam repairing.

### BACKGROUND OF THE DISCLOSURE

A baking system may perform preliminary illumination calculation on illumination received by virtual objects in a three-dimensional virtual scene, and illumination data generated by the calculation is stored in a two-dimensional illumination map. In a scene with a fixed light source, replacing real-time illumination calculation with an illumination map may reduce resource consumption, thereby improving scene operation efficiency. For example, for a game field, when a virtual object model in a game scene is rendered, real-time illumination calculation may be replaced with an illumination map, thereby improving model rendering efficiency. However, continuous texels in a three-dimensional mesh model may not correspond to continuous positions in the illumination map. Illumination data corresponding to the texels at discontinuous positions in the illumination map differ greatly, thereby leading to a seam effect on a model obtained by illumination rendering based on the illumination map.

In the related art, texels that may cause seams in a model may be found in a manner of traversing model vertices one by one, leading to low search efficiency of seam texels, and the problem of low search efficiency of seam texels is particularly prominent for open large-world scenes, thereby resulting in low efficiency in seam repair for the model.

### SUMMARY

This disclosure provides a model seam repairing method and apparatus, a device, and a medium.

Some aspects of the disclosure provide a method of model seam repairing. In some examples, a ray emission region perpendicular to a normal direction of a sampled texel in a first mesh patch of a first initial three-dimensional mesh model in a three-dimensional virtual scene is constructed, the three-dimensional virtual scene includes one or more initial three-dimensional mesh models including the first initial three-dimensional mesh model. One or more rays that start in the ray emission region and extend in an opposite direction of the normal direction of the sampled texel are constructed. One or more candidate texels in the one or more initial three-dimensional mesh models are determined, the one or more candidate texels respectively intersect with at least a ray in the one or more rays. When the one or more candidate texels include at least one spatially adjacent texel of the sampled texel, the sampled texel is determined as a first seam texel. From the at least one spatially adjacent texel, a second seam texel that has a seam adjacency relationship with the first seam texel is determined. At least a seam repair of the first seam texel and the second seam texel is performed to obtain a target three-dimensional mesh model.

Some aspects of the disclosure provide an image processing apparatus that includes processing circuitry configured to perform the method of model seam repairing.

Some aspects of the disclosure also provide a non-transitory computer-readable storage medium storing instructions which when executed by at least one processor cause the at least one processor to perform the method of model seam repairing.

According to a first aspect, this disclosure provides a model seam repairing method, including: determining sampled texels obtained by sampling texels of an initial three-dimensional mesh model in a three-dimensional virtual scene, and for each of the sampled texels, constructing a ray emission region perpendicular to a normal direction of the sampled texel; constructing at least one ray by taking a point in the ray emission region as a ray starting point and taking a direction opposite to the normal direction of the sampled texel as a ray direction, and determining texels in the initial three-dimensional mesh model that intersect any one of the at least one ray, to obtain at least one candidate texel; determining, if at least one spatially adjacent texel of the sampled texel exists in the at least one candidate texel, the sampled texel as a first seam texel; determining, from the at least one spatially adjacent texel, a second seam texel having a seam adjacency relationship with the first seam texel; and repairing the first seam texel and the second seam texel in the initial three-dimensional mesh model, to obtain a target three-dimensional mesh model after seam repair.

According to a second aspect, this disclosure provides a model seam repairing apparatus, including: a construction module, configured to determine sampled texels obtained by sampling texels of an initial three-dimensional mesh model in a three-dimensional virtual scene, and for each of the sampled texels, construct a ray emission region perpendicular to a normal direction of the sampled texel; a determination module, configured to construct at least one ray by taking a point in the ray emission region as a ray starting point and take a direction opposite to the normal direction of the sampled texel as a ray direction, and determine texels in the initial three-dimensional mesh model that intersect any one of the at least one ray, to obtain at least one candidate texel; a judgment module, configured to determine, if at least one spatially adjacent texel of the sampled texel exists in the at least one candidate texel, the sampled texel as a first seam texel; the determination module being further configured to determine, from the at least one spatially adjacent texel, a second seam texel having a seam adjacency relationship with the first seam texel; and a repair module, configured to repair the first seam texel and the second seam texel in the initial three-dimensional mesh model, to obtain a target three-dimensional mesh model after seam repair.

According to a third aspect, this disclosure provides a computer device, including a memory and a processor (an example of processing circuitry), the memory having a computer program stored therein, and the processor, when executing the computer program, implementing operations in the method embodiments of this disclosure.

According to a fourth aspect, this disclosure provides a computer-readable storage medium (e.g., non-transitory computer-readable storage medium), having a computer program stored therein, when the computer program is executed by a processor, operations in the method embodiments of this disclosure being implemented.

According to a fifth aspect, this disclosure provides a computer program product, including a computer program, when the computer program is executed by a processor, operations in the method embodiments of this disclosure being implemented.

Details of one or more embodiments of this disclosure are set forth in the accompanying drawings and descriptions below. Other features, objectives, and advantages of this disclosure become apparent from the specification, the drawings, and the claims.

### BRIEF DESCRIPTION OF THE DRAWINGS

FIG. 1 is a diagram of an application environment of a model seam repairing method according to an embodiment.

FIG. 2 is a schematic flowchart of a model seam repairing method according to an embodiment.

FIG. 3 is a schematic diagram of construction of a ray emission region according to an embodiment.

FIG. 4 is a schematic diagram of a process of searching for a first seam texel and a second seam texel according to an embodiment.

FIG. 5 is a schematic diagram of a process of determining a denoising reference region corresponding to a to-be-repaired seam texel according to an embodiment.

FIG. 6 is a schematic diagram of a process of determining a denoising reference region corresponding to a to-be-repaired seam texel according to another embodiment.

FIG. 7 is a schematic diagram of a parameter configuration interface for model seam repair according to an embodiment.

FIG. 8 is a schematic diagram showing comparisons before and after seam repair for a single model according to an embodiment.

FIG. 9 is a schematic diagram showing comparisons before and after seam repair for a plurality of models according to an embodiment.

FIG. 10 is a schematic flowchart of a model seam repairing method according to another embodiment.

FIG. 11 is a structural block diagram of a model seam repairing apparatus according to an embodiment.

FIG. 12 is a diagram of an internal structure of a computer device according to an embodiment.

FIG. 13 is a diagram of an internal structure of a computer device according to another embodiment.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

A model seam repairing method provided in this disclosure may be applied to an application environment shown in FIG. 1. A terminal 102 communicates with a server 104 by using a network. A data storage system may be disposed separately to store data that the server 104 needs to process. The data storage system may be integrated on the server 104, or may be placed on a cloud or another server. The terminal 102 may be, but is not limited to, various desktop computers, notebook computers, smart phones, tablet computers, Internet of Things devices, and portable wearable devices. The Internet of Things devices may be smart speakers, smart televisions, smart air conditioners, smart vehicle-mounted devices, or the like. The portable wearable devices may be smart watches, smart bands, head-mounted devices, or the like. The server 104 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, network security services such as cloud security, host security, a content delivery network (CDN), big data, and an artificial intelligence platform. The terminal 102 and the server 104 may be directly or indirectly connected in a wired or wireless communication manner, which is not limited in this disclosure.

For each sampled texel in an initial three-dimensional mesh model in a three-dimensional virtual scene, the server 104 may construct a ray emission region perpendicular to a normal direction of the sampled texel, construct at least one ray by taking a point in the ray emission region as a ray starting point and taking a direction opposite to the normal direction of the sampled texel as a ray direction, and determine texels in the initial three-dimensional mesh model that intersect any one of the at least one ray, to obtain at least one candidate texel. If at least one spatially adjacent texel of the sampled texel exists in the at least one candidate texel, the server 104 may determine the sampled texel as a first seam texel; and determine, from the at least one spatially adjacent texel, a second seam texel having a seam adjacency relationship with the first seam texel. The server 104 may repair the first seam texel and the second seam texel in the initial three-dimensional mesh model, to obtain a target three-dimensional mesh model after seam repair.

The server 104 may transmit the target three-dimensional mesh model after seam repair to the terminal 102 for display. This is not limited in this embodiment. The application scene in FIG. 1 is merely for illustration and is not limited thereto.

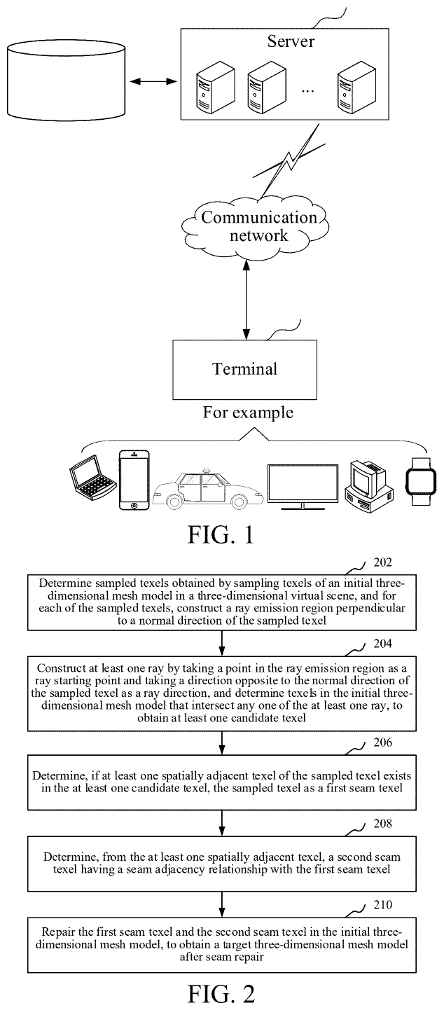

In an embodiment, as shown in FIG. 2, a model seam repairing method is provided. The method may be applied to a computer device. The computer device may be a terminal or a server. The method may be performed by the terminal or the server alone, or may be implemented through interaction between the terminal and the server. This embodiment is described by using an example in which the method is applied to a computer device, including the following operations:

Operation 202: Determine sampled texels obtained by sampling texels of an initial three-dimensional mesh model in a three-dimensional virtual scene, and for each of the sampled texels, constructing a ray emission region perpendicular to a normal direction of the sampled texel.

The three-dimensional virtual scene is a virtual scene in a three-dimensional space. For example, the three-dimensional virtual scene may include at least one of a game scene, a film and television special effects scene, a visual design scene, a virtual reality (VR) scene, an industrial simulation scene, and a digital cultural and creative scene. The three-dimensional mesh model is a mesh model in the three-dimensional virtual scene. The mesh model is a virtual model including at least one mesh patch. The mesh patch is a unit patch in a tessellated mesh model. The mesh patch may be a patch in a polygonal shape. For example, the mesh patch may be a triangular mesh patch or a quadrilateral mesh patch, which is not limited in this embodiment. The initial three-dimensional mesh model is a three-dimensional mesh model before seam repair. The initial three-dimensional mesh model is a to-be-repaired three-dimensional mesh model. There may be seams on the initial three-dimensional mesh model. In this case, rendering quality of the initial three-dimensional mesh model is low. The sampled texel is a texel sampled from the initial three-dimensional mesh model. The normal direction of the sampled texel is a direction of a normal vector of the sampled texel. The ray emission region is a region configured for emitting a ray and in the three-dimensional virtual scene. The ray emission region may be a region constructed by moving by a preset distance from the sampled texel along a direction of the normal vector of the sampled texel. A plane where the ray emission region is located is perpendicular to the direction of the normal vector of the sampled texel.

In some examples, the three-dimensional virtual scene includes at least one initial three-dimensional mesh model, the initial three-dimensional mesh model includes at least one mesh patch, and each mesh patch includes a plurality of texels. The computer device may sample texels in the initial three-dimensional mesh model, to obtain sampled texels. For each sampled texel, the computer device may move by a preset distance along the direction of the normal vector of the sampled texel, and construct, at a position at a preset distance from the sampled texel, the ray emission region perpendicular to the normal direction of the sampled texel.

In an embodiment, the initial three-dimensional mesh model includes at least one mesh patch including a plurality of edges, and each mesh patch includes a plurality of texels. The computer device may sample texels on the edges in the mesh patch of the initial three-dimensional mesh model, to obtain the sampled texels. Since a process of obtaining a planar mesh model by performing two-dimensional flattening on the initial three-dimensional mesh model is performed based on mesh vertices in the mesh patch, texels that are continuous in the three-dimensional virtual scene but discontinuous in an illumination map corresponding to the initial three-dimensional mesh model are all located on edges of the mesh patch. The illumination map may be obtained by recording illumination data generated by illumination calculation for texels in the planar mesh model. The texels on the edges in the mesh patch of the initial three-dimensional mesh model are sampled to obtain the sampled texels, and a subsequent seam texel search is performed based on the sampled texels, which can further improve accuracy of the seam texel search.

In an embodiment, the computer device may, for example randomly, sample the texels in the initial three-dimensional mesh model, to obtain the sampled texels.

In an embodiment, for each sampled texel, the computer device may take a texel radius of the sampled texel as a preset distance, take the texel radius of the sampled texel as a moving distance, and move along the direction of the normal vector of the sampled texel. The movement is stopped when the moving distance reaches a distance corresponding to the texel radius of the sampled texel. The computer device may perform diffusion around in a tangent space corresponding to the sampled texel by taking the sampled texel as a center point at a position where the movement is stopped, to construct the ray emission region perpendicular to the normal direction of the sampled texel.

In an embodiment, for each sampled texel, the computer device may perform diffusion around in the tangent space corresponding to the sampled texel by taking the sampled texel as a center point and taking the texel radius of the sampled texel as an offset at the position where the movement is stopped, to construct the ray emission region perpendicular to the normal direction of the sampled texel.

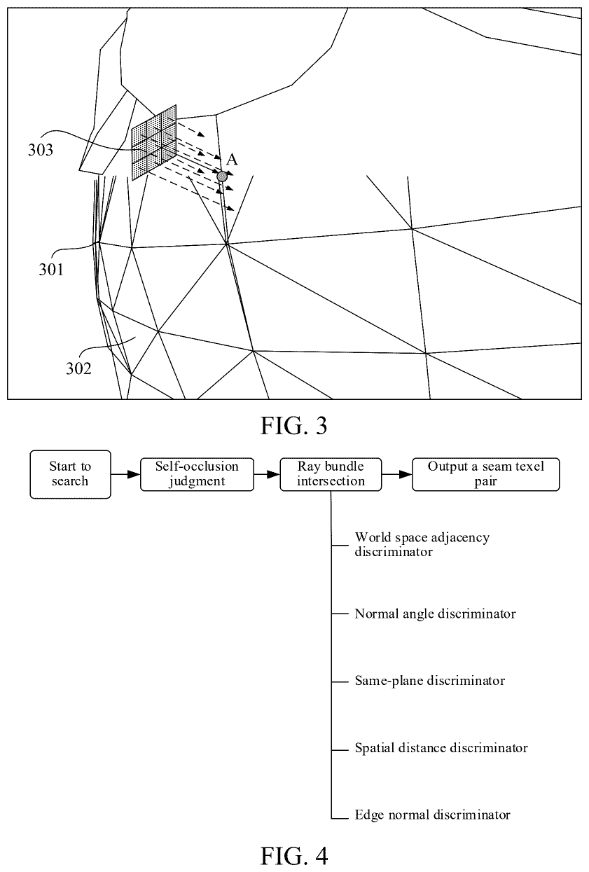

In an embodiment, as shown in FIG. 3, the three-dimensional virtual scene includes at least one initial three-dimensional mesh model 301, and the initial three-dimensional mesh model 301 includes at least one mesh patch 302. In this embodiment, the mesh patch 302 is a triangular mesh patch. For each sampled texel A in the initial three-dimensional mesh model 301, the computer device may move by a preset distance from the sampled texel A along a direction of a normal vector of the sampled texel A, and construct, at a position at a preset distance from the sampled texel A, a ray emission region 303 perpendicular to a normal direction of the sampled texel A.

Operation 204: Construct at least one ray by taking a point in the ray emission region as a ray starting point and taking a direction opposite to the normal direction of the sampled texel as a ray direction, and determine texels in the initial three-dimensional mesh model that intersect any one of the at least one ray, to obtain at least one candidate texel.

In some examples, the ray emission region includes a plurality of points, and the computer device may construct at least one ray by taking a point in the ray emission region and meeting a target condition as a ray starting point and taking a direction opposite to the normal direction of the sampled texel as a ray direction. Then, the computer device may determine at least one texel in the initial three-dimensional mesh model and respectively intersecting the rays, to obtain at least one candidate texel.

In an embodiment, the computer device may determine texels in the initial three-dimensional mesh model that intersect any one of the at least one ray, to obtain intersecting texels, and directly take the obtained intersecting texels as candidate texels. The intersecting texels are texels in the initial three-dimensional mesh model that intersect any one of the at least one ray.

In an embodiment, the computer device may select at least one candidate texel from the intersecting texels. For example, the computer device may, for example randomly, select at least one candidate texel from the intersecting texels.

In an embodiment, still referring to FIG. 3, the computer device may construct at least one ray by taking a point in the ray emission region 303 and meeting a target condition as a ray starting point and taking a direction opposite to the normal direction of the sampled texel A as a ray direction. Then, the computer device may determine at least one texel in the initial three-dimensional mesh model 301 and respectively intersecting the rays, to obtain at least one candidate texel.

Operation 206: Determine, if at least one spatially adjacent texel of the sampled texel exists in the at least one candidate texel, the sampled texel as a first seam texel.

The spatially adjacent texel of the sampled texel is a texel adjacent to the sampled texel in the three-dimensional virtual scene. The three-dimensional virtual scene is located in a three-dimensional world space. Therefore, the texel adjacent to the sampled texel in the three-dimensional virtual scene is a texel adjacent to the sampled texel in the world space. A seam texel is a texel causing a seam effect on the initial three-dimensional mesh model. In a case that the sampled texel has at least one spatially adjacent texel, the sampled texel may be determined as a seam texel, to obtain the first seam texel. In a case that the sampled texel has at least one spatially adjacent texel, the sampled texel may be directly determined as the first seam texel.

In some examples, for each candidate texel, the computer device may determine whether the candidate texel is adjacent to the sampled texel in the three-dimensional virtual scene, thereby determining whether the candidate texel belongs to a spatially adjacent texel of the sampled texel. If at least one spatially adjacent texel of the sampled texel exists in the candidate texels, the computer device may determine the sampled texel as the first seam texel.

In an embodiment, for each candidate texel, the computer device may determine a distance between the candidate texel and the sampled texel in the three-dimensional virtual scene, to obtain a spatial distance corresponding to the candidate texel. If there is a candidate texel whose spatial distance is less than a preset spatial distance, a spatially adjacent texel of the sampled texel exists in the candidate texels, and the computer device may determine the sampled texel as the first seam texel. The computer device may take the candidate texel whose spatial distance is less than the preset spatial distance as the spatially adjacent texel of the sampled texel.

Operation 208: Determine, from the at least one spatially adjacent texel, a second seam texel having a seam adjacency relationship with the first seam texel.

The second seam texel is a spatially adjacent texel having the seam adjacency relationship with the first seam texel. There is a seam adjacency relationship between the first seam texel and the second seam texel. The first seam texel and the second seam texel may form a texel pair, and the texel pair may cause a seam effect on the initial three-dimensional mesh model. The first seam texel and the second seam texel in the texel pair are respectively located on two sides of a seam of the initial three-dimensional mesh model.

In an embodiment, the computer device may, for example randomly, select, from the at least one spatially adjacent texel, one spatially adjacent texel as the second seam texel having the seam adjacency relationship with the first seam texel.

Operation 210: Repair the first seam texel and the second seam texel in the initial three-dimensional mesh model, to obtain a target three-dimensional mesh model after seam repair.

The target three-dimensional mesh model is a three-dimensional mesh model obtained after seam repair on the initial three-dimensional mesh model. There is a seam effect on the initial three-dimensional mesh model, leading to lower model rendering quality. After seam repair on the initial three-dimensional mesh model, a target three-dimensional mesh model without seam effects may be obtained, thereby improving the model rendering quality.

In some examples, the computer device may acquire illumination data recorded for the first seam texel in the initial three-dimensional mesh model and acquire illumination data recorded for the second seam texel in the initial three-dimensional mesh model. A difference between the illumination data recorded for the first seam texel and the illumination data recorded for the second seam texel is large, resulting in a seam effect on the initial three-dimensional mesh model. Therefore, the computer device may denoise the illumination data recorded for the first seam texel and the illumination data recorded for the second seam texel and reduce the difference between the illumination data recorded for the first seam texel and the illumination data recorded for the second seam texel, thereby repairing the first seam texel and the second seam texel to obtain the target three-dimensional mesh model after seam repair. The illumination data is data that describes illumination, which may describe a color and intensity of illumination. Correspondingly, the illumination data may include a color value and a brightness value. An illumination difference may include a color value difference and a brightness value difference.

In an embodiment, the computer device may determine a texel in the initial three-dimensional mesh model and adjacent to the first seam texel and determine a texel in the initial three-dimensional mesh model and adjacent to the second seam texel. The computer device may acquire illumination data recorded for the texel adjacent to the first seam texel and acquire illumination data recorded for the texel adjacent to the second seam texel. Then, the computer device may denoise the illumination data recorded for the first seam texel with reference to the illumination data recorded for the texel adjacent to the first seam texel and denoise the illumination data recorded for the second seam texel with reference to the illumination data recorded for the texel adjacent to the second seam texel, thereby repairing the first seam texel and the second seam texel to obtain the target three-dimensional mesh model after seam repair.

In the above model seam repairing method, for each sampled texel in an initial three-dimensional mesh model in a three-dimensional virtual scene, a ray emission region perpendicular to a normal direction of the sampled texel is constructed, at least one ray is constructed by taking a point in the ray emission region as a ray starting point and taking a direction opposite to the normal direction of the sampled texel as a ray direction, and texels in the initial three-dimensional mesh model that intersect any one of the at least one ray are determined, to obtain at least one candidate texel. If at least one spatially adjacent texel of the sampled texel exists in the at least one candidate texel, the sampled texel may be quickly determined as a first seam texel. A second seam texel having a seam adjacency relationship with the first seam texel may be quickly determined from the at least one spatially adjacent texel. Then, the first seam texel and the second seam texel in the initial three-dimensional mesh model are quickly repaired, to obtain a target three-dimensional mesh model after seam repair. Compared with the related manner of traversing model vertices one by one to search for seam texels, in the seam searching manner in this disclosure, there is no need to traverse model vertices to search for seam texels; instead, a ray emission region is constructed and rays are generated by the ray emission region to intersect with the initial three-dimensional mesh model to search for the seam texels, which improves search efficiency of model seam texels. Then, the first seam texel and the second seam texel quickly found are repaired, which can improve model seam repair efficiency.

In an embodiment, the determining sampled texels obtained by sampling texels of an initial three-dimensional mesh model in a three-dimensional virtual scene includes: for each of the texels in the initial three-dimensional mesh model, ignoring, in the three-dimensional virtual scene, the texel if an occlusion mesh patch exists within a preset range along a normal direction of the texel from the texel; the occlusion mesh patch being a mesh patch in the initial three-dimensional mesh model other than a mesh patch where the texel is located; and taking the texels not ignored in the initial three-dimensional mesh model as the sampled texels.

Texel is the abbreviation of texture element, which is a basic unit in a computer graphics texture space. Textures are represented by arrangements of texels. For each texel in the initial three-dimensional mesh model, an occlusion mesh patch corresponding to the texel is a mesh patch in the initial three-dimensional mesh model other than a mesh patch where the texel is located and occluding illumination of the texel.

In some examples, for each texel in the initial three-dimensional mesh model, in the three-dimensional virtual scene, if the occlusion mesh patch exists within the preset range along the normal direction of the texel from the texel, illumination of the texel may be occluded by the occlusion mesh patch, and illumination data corresponding to the occluded texel is also quite different from illumination data corresponding to an adjacent texel thereof. In this case, the computer device may ignore the occluded texel. Moreover, the texels not ignored in the initial three-dimensional mesh model are taken as the sampled texels. “The computer device ignores the occluded texel” means that the computer device may automatically skip these obscured texels when sampling the texels in the initial three-dimensional mesh model. That is, the computer device may not sample the occluded texels.

In an embodiment, the preset range is determined by using a texel radius of the texel. For example, the preset range is a range corresponding to the texel radius of the texel. For each texel in the initial three-dimensional mesh model, in the three-dimensional virtual scene, the texel is ignored if an occlusion mesh patch exists within a texel radius along the normal direction of the texel. In this way, since a length of the texel radius of the texel may represent a size of a region covered by the texel in the initial three-dimensional mesh model, accuracy of the seam texel search can be further improved by ignoring a texel that has an occlusion mesh patch within a texel radius.

In the above embodiments, for each texel in the initial three-dimensional mesh model, whether occlusion mesh patches exist around the mesh patch where the texel is located is determined, and if the occlusion mesh patches exist, the texel is occluded by the occlusion mesh patches therearound. The illumination data corresponding to the occluded texel is also quite different from the illumination data corresponding to the adjacent texel thereof. Therefore, non-occluded texels in the initial three-dimensional mesh model are taken as sampled texels for a subsequent seam texel search, which can improve accuracy of the seam texel search.

In an embodiment, the determining texels in the initial three-dimensional mesh model that intersect any one of the at least one ray, to obtain at least one candidate texel includes: determining the texels in the initial three-dimensional mesh model that intersect any one of the at least one ray, to obtain intersecting texels; and for each of the intersecting texels, taking the intersecting texel as a candidate texel if coordinates of the intersecting texel in a planar mesh model are discontinuous with coordinates of the sampled texel in the planar mesh model or the intersecting texel and the sampled texel are located in different initial three-dimensional mesh models; where the planar mesh model is a mesh model after two-dimensional flattening on the initial three-dimensional mesh model.

The intersecting texels are texels in the initial three-dimensional mesh model that intersect the rays. The planar mesh model is a mesh model after two-dimensional flattening on the initial three-dimensional mesh model. The planar mesh model is a mesh model in a two-dimensional space.

In some examples, the computer device may take the texels in the initial three-dimensional mesh model that intersect the rays as intersecting texels. A quantity of the intersecting texels is at least one. The computer device may unfold the initial three-dimensional mesh model in the two-dimensional space to obtain the planar mesh model after two-dimensional flattening on the initial three-dimensional mesh model. The texels in the initial three-dimensional mesh model have a mapping relationship with texels in the planar mesh model. For each intersecting texel, the computer device may acquire coordinates of the intersecting texel in the planar mesh model and acquire coordinates of the sampled texel in the planar mesh model. In the initial three-dimensional mesh model, a quantity of the initial three-dimensional mesh model is at least one. If the coordinates of the intersecting texel in the planar mesh model are discontinuous with the coordinates of the sampled texel in the planar mesh model or the intersecting texel and the sampled texel are located in different initial three-dimensional mesh models, the intersecting texel is a potential seam texel. That is, the intersecting texel may be a texel that causes a seam in the model. The computer device may take the intersecting texel as a candidate texel.

In the above embodiments, for each intersecting texel, if the coordinates of the intersecting texel in the planar mesh model are discontinuous with the coordinates of the sampled texel in the planar mesh model or the intersecting texel and the sampled texel are located in different initial three-dimensional mesh models, the intersecting texel is a potential seam texel. That is, the intersecting texel may be a texel that causes a seam in the model. The potential seam texels preliminarily screened out are used as candidate texels, and then true seam texels are filtered out in an advanced manner from the candidate texels obtained through preliminary screening, which can further improve the efficiency of the seam texel search.

In an embodiment, the method further includes: for each candidate texel, determining the candidate texel as a spatially adjacent texel of the sampled texel if a first mesh patch corresponding to the candidate texel and a second mesh patch corresponding to the sampled texel are continuous in the three-dimensional virtual scene; where the first mesh patch is a mesh patch where the candidate texel is located in the initial three-dimensional mesh model; and the second mesh patch is a mesh patch where the sampled texel is located in the initial three-dimensional mesh model.

In some examples, for each candidate texel, the computer device may determine whether the first mesh patch where the candidate texel is located and the second mesh patch where the sampled texel is located are continuous in the three-dimensional virtual scene. The computer device may determine the candidate texel as a spatially adjacent texel of the sampled texel if the first mesh patch corresponding to the candidate texel and the second mesh patch corresponding to the sampled texel are continuous in the three-dimensional virtual scene.

In an embodiment, the computer device may determine new candidate texels by iteratively reducing the ray emission region, and then determine the spatially adjacent texel of the sampled texel from the new candidate texels.

In an embodiment, the computer device may decrement an offset used in the construction of the ray emission region at a rate of half of the texel radius of the sampled texel, to determine the spatially adjacent texel of the sampled texel. In some examples, for each sampled texel, the computer device may take the sampled texel as a center point, take half of an offset corresponding to a previous round as an offset of this round, and perform diffusion around in the tangent space corresponding to the sampled texel according to the offset corresponding to this round, to construct a ray emission region perpendicular to the normal direction of the sampled texel and corresponding to this round. An area of the ray emission region corresponding to this round is smaller than an area of a ray emission region corresponding to the previous round. When a texel intersecting the sampled texel exists in candidate texels obtained based on a ray emission region newly constructed in this round, candidate texels obtained based on a ray emission region newly constructed in the previous round are taken as spatially adjacent texels of the sampled texel.

In an embodiment, the mesh patch includes a plurality of mesh vertices, and if at least one identical mesh vertex exists in the first mesh patch where the candidate texel is located and the second mesh patch where the sampled texel is located, the computer device may determine whether the first mesh patch and the second mesh patch are continuous in the three-dimensional virtual scene.

In the above embodiments, for each candidate texel, since the mesh patches where two texels continuous in the three-dimensional virtual scene are respectively located are definitely continuous in the three-dimensional virtual scene, whether the first mesh patch corresponding to the candidate texel and the second mesh patch corresponding to the sampled texel are continuous in the three-dimensional virtual scene is determined, thereby determining, based on a judgment result, whether the candidate texel is a spatially adjacent texel of the sampled texel, which can improve accuracy of judgment of the spatially adjacent texel.

In an embodiment, the determining, from the at least one spatially adjacent texel, a second seam texel having a seam adjacency relationship with the first seam texel includes: selecting, from the at least one spatially adjacent texel according to at least one of an illumination difference between illumination data of the spatially adjacent texel and illumination data of the first seam texel, a plane difference between a mesh patch where the spatially adjacent texel is located and a mesh patch where the first seam texel is located, a spatial distance between the spatially adjacent texel and the first seam texel in the three-dimensional virtual scene, and an intersection area between a coverage region of the spatially adjacent texel in the initial three-dimensional mesh model and a coverage region of the first seam texel in the initial three-dimensional mesh model, the spatially adjacent texel meeting a target condition; and determining the second seam texel from the selected spatially adjacent texel.

Data according to which the spatially adjacent texel meeting the target condition is selected from the at least one spatially adjacent texel may be pre-specified, which may be specified in a configuration file or hardened in algorithm code, thereby selecting, from the at least one spatially adjacent texel according to at least one of the illumination difference, the plane difference, the spatial distance, and the intersection area based on hardening logic in the configuration file or algorithm code, the spatially adjacent texel meeting the target condition; and the second seam texel is determined from the selected spatially adjacent texel.

In some examples, the computer device may select, from the at least one spatially adjacent texel according to at least one of the illumination difference between illumination data of the spatially adjacent texel and illumination data of the first seam texel, the plane difference between the mesh patch where the spatially adjacent texel is located and the mesh patch where the first seam texel is located, i.e., whether the mesh patch where the spatially adjacent texel is located and the mesh patch where the first seam texel is located are on the same plane, a spatial distance between a position of the spatially adjacent texel in the three-dimensional virtual scene and a position of the first seam texel in the three-dimensional virtual scene, and the intersection area between the coverage region of the spatially adjacent texel in the initial three-dimensional mesh model and the coverage region of the first seam texel in the initial three-dimensional mesh model, the spatially adjacent texel meeting the target condition. Then, the computer device may determine the second seam texel from the selected spatially adjacent texel.

In an embodiment, firstly, the computer device may select, from the at least one spatially adjacent texel according to the illumination difference between the illumination data of the spatially adjacent texel and the illumination data of the first seam texel, the spatially adjacent texel meeting the target condition. Then, the computer device may select, from the spatially adjacent texel selected based on the illumination difference, the spatially adjacent texel meeting the target condition according to the plane difference between the mesh patch where the spatially adjacent texel is located and the mesh patch where the first seam texel is located. Further, the computer device may select, from the spatially adjacent texel selected based on the plane difference, the spatially adjacent texel meeting the target condition according to the spatial distance between the spatially adjacent texel and the first seam texel in the three-dimensional virtual scene. Finally, the computer device may select, from the spatially adjacent texel selected based on the spatial distance, one spatially adjacent texel as the second seam texel according to the intersection area between the coverage region of the spatially adjacent texel in the initial three-dimensional mesh model and the coverage region of the first seam texel in the initial three-dimensional mesh model.

In the above embodiments, the spatially adjacent texel meeting the target condition is selected from the at least one spatially adjacent texel in at least one screening manner of the illumination difference, the plane difference, the spatial distance, and the intersection area, which can improve accuracy of screening of some spatially adjacent texels. Then, the second seam texel is determined from more accurate selected spatially adjacent texels, which can improve accuracy of screening of the second seam texel.

In an embodiment, the selecting, from the at least one spatially adjacent texel, the spatially adjacent texel meeting a target condition includes: in a case that the at least one spatially adjacent texel is screened according to the illumination difference between the illumination data of the spatially adjacent texel and the illumination data of the first seam texel, for each of the at least one spatially adjacent texel, determining a normal angle between the mesh patches corresponding to the spatially adjacent texel and the first seam texel, to obtain a first angle corresponding to the spatially adjacent texel; the first angle being positively correlated with the illumination difference; and selecting, from the at least one spatially adjacent texel, the spatially adjacent texel with the first angle less than or equal to a preset angle.

The normal angle is an angle between a normal of the mesh patch corresponding to the spatially adjacent texel and a normal of the mesh patch corresponding to the first seam texel. The first angle is the normal angle between the mesh patches corresponding to the spatially adjacent texel and the first seam texel. “The first angle being positively correlated with the illumination difference” may be understood as that a larger first angle indicates a larger illumination difference between the illumination data of the spatially adjacent texel and the illumination data of the first seam texel. A smaller first angle indicates a smaller illumination difference between the illumination data of the spatially adjacent texel and the illumination data of the first seam texel.

In an embodiment, in a case that the at least one spatially adjacent texel is screened according to the illumination difference between the illumination data of the spatially adjacent texel and the illumination data of the first seam texel, for each spatially adjacent texel, the computer device may determine a normal angle between the normal of the mesh patch corresponding to the spatially adjacent texel and the normal of the mesh patch corresponding to the first seam texel, and take the normal angle as the first angle corresponding to the spatially adjacent texel. The first angle is positively correlated with the illumination difference. Then, the computer device may select, from the at least one spatially adjacent texel, the spatially adjacent texel with the first angle less than or equal to a preset angle. The computer device may select, from the at least one spatially adjacent texel, a spatially adjacent texel with a smaller illumination difference.

In the above embodiments, in a case that the spatially adjacent texel meeting the target condition is selected according to the illumination difference, since the first angle is positively correlated with the illumination difference, the spatially adjacent texel with the first angle less than or equal to the preset angle is selected by using the first angle between the normals corresponding to the mesh patches, which can select the spatially adjacent texel with the smaller illumination difference, thereby improving search accuracy of the second seam texel.

In an embodiment, the selecting, from the at least one spatially adjacent texel, the spatially adjacent texel meeting a target condition includes: in a case that the at least one spatially adjacent texel is screened according to the plane difference between the mesh patch where the spatially adjacent texel is located and the mesh patch where the first seam texel is located, selecting, from the at least one spatially adjacent texel, a spatially adjacent texel having a patch coplanarity relationship with the first seam texel; where a mesh patch corresponding to the selected spatially adjacent texel and the mesh patch corresponding to the first seam texel are on the same plane.

The patch coplanarity relationship means that mesh patches where two seam texels are located are on the same plane. Spatially adjacent texels that are not in an overlapping relationship may be screened out by selecting, from the at least one spatially adjacent texel, the spatially adjacent texel having the patch coplanarity relationship with the first seam texel. For example, a situation where an accessory such as a belt floats above a surface of clothing and is mistaken for a seam can be prevented.

In some examples, in a case that the at least one spatially adjacent texel is screened according to the plane difference between the mesh patch where the spatially adjacent texel is located and the mesh patch where the first seam texel is located, the computer device may determine whether each spatially adjacent texel has the patch coplanarity relationship with the first seam texel, i.e., determine whether the mesh patch where the spatially adjacent texel is located and the mesh patch where the first seam texel is located are on the same plane. Then, the computer device may select, from the at least one spatially adjacent texel, the spatially adjacent texel having the patch coplanarity relationship with the first seam texel. A mesh patch corresponding to the spatially adjacent texel selected based on the plane difference and the mesh patch corresponding to the first seam texel are on the same plane.

In an embodiment, for each spatially adjacent texel, the computer device may project a vector between the spatially adjacent texel and the first seam texel onto the normal of the mesh patch corresponding to the first seam texel, to obtain a projection line segment corresponding to the spatially adjacent texel. Then, the computer device may determine a spatially adjacent texel corresponding to a projection line segment whose length is less than or equal to a preset length as the spatially adjacent texel having the patch coplanarity relationship with the first seam texel.

In the above embodiments, in a case that the spatially adjacent texel meeting the target condition is selected according to the plane difference, the spatially adjacent texel having the patch coplanarity relationship with the first seam texel definitely has no overlapping relationship with the first seam texel. Therefore, spatially adjacent texels that are not in an overlapping relationship can be screened out by selecting, from the at least one spatially adjacent texel, the spatially adjacent texel having the patch coplanarity relationship with the first seam texel, thereby improving search accuracy of the second seam texel.

In an embodiment, the selecting, from the at least one spatially adjacent texel, the spatially adjacent texel meeting a target condition includes: in a case that the at least one spatially adjacent texel is screened according to the spatial distance between the spatially adjacent texel and the first seam texel in the three-dimensional virtual scene, selecting, from the at least one spatially adjacent texel, the spatially adjacent texel with the spatial distance less than or equal to a preset distance; where the preset distance is less than or equal to a texel radius of the first seam texel.

In some examples, in a case that the at least one spatially adjacent texel is screened according to the spatial distance between the spatially adjacent texel and the first seam texel in the three-dimensional virtual scene, the computer device may determine a spatial distance between a position of each spatially adjacent texel in the three-dimensional virtual scene and a position of the first seam texel in the three-dimensional virtual scene. Then, the computer device may select, from the at least one spatially adjacent texel, the spatially adjacent texel with the spatial distance less than or equal to the preset distance.

In the above embodiments, in a case that the spatially adjacent texel meeting the target condition is selected according to the spatial distance, since the spatial distance between two texels is excessively large, regions covered by the two texels are discontinuous in the three-dimensional virtual space. Therefore, spatially adjacent texels whose coverage regions are continuous with the coverage region of the first seam texel in the three-dimensional virtual space can be filtered out by selecting, from the at least one spatially adjacent texel, the spatially adjacent texel with the spatial distance less than or equal to the preset distance, thereby improving search accuracy of the second seam texel.

In an embodiment, the selecting, from the at least one spatially adjacent texel, the spatially adjacent texel meeting a target condition includes: in a case that the at least one spatially adjacent texel is screened according to the intersection area between the coverage region of the spatially adjacent texel in the initial three-dimensional mesh model and the coverage region of the first seam texel in the initial three-dimensional mesh model, for each of the at least one spatially adjacent texel, determining an angle between a texel vector and a reverse edge normal vector corresponding to the first seam texel, to obtain a second angle corresponding to the spatially adjacent texel; the texel vector being a vector pointing from the first seam texel to the spatially adjacent texel; the reverse edge normal vector being opposite to a direction of an edge normal of the first seam texel; and selecting, from the at least one spatially adjacent texel, the spatially adjacent texel with a minimum second angle; where a size of the second angle is negatively correlated with a size of the intersection area.

An edge normal of a texel is a direction vector of a perpendicular line between an edge of the texel and an opposite mesh vertex in a mesh patch. A direction of the edge normal of the texel is from the edge of the texel to the opposite mesh vertex. The edge normal of the first seam texel is a direction vector of a perpendicular line between an edge of the first seam texel and an opposite mesh vertex in the mesh patch.

In an embodiment, in a case that the at least one spatially adjacent texel is screened according to the intersection area between the coverage region of the spatially adjacent texel in the initial three-dimensional mesh model and the coverage region of the first seam texel in the initial three-dimensional mesh model, for each spatially adjacent texel, the computer device may take the vector pointing from the first seam texel to the spatially adjacent texel as the texel vector and the vector opposite to the direction of the edge normal of the first seam texel as the reverse edge normal vector. The computer device may determine the angle between the texel vector and the reverse edge normal vector corresponding to the first seam texel, to obtain the second angle corresponding to the spatially adjacent texel. “A size of the second angle is negatively correlated with a size of the intersection area” means that a smaller second angle indicates a larger intersection area between the coverage region of the spatially adjacent texel in the initial three-dimensional mesh model and the coverage region of the first seam texel in the initial three-dimensional mesh model and a larger second angle indicates a smaller intersection area between the coverage region of the spatially adjacent texel in the initial three-dimensional mesh model and the coverage region of the first seam texel in the initial three-dimensional mesh model. Then, the computer device may select, from the at least one spatially adjacent texel, the spatially adjacent texel with the minimum second angle. The computer device may screen out spatially adjacent texels with a maximum intersection area.

In the above embodiments, in a case that the spatially adjacent texel meeting the target condition is selected according to the intersection area, the size of the second angle is negatively correlated with the size of the intersection area. Therefore, the spatially adjacent texels with the maximum intersection area can be screened out by selecting, from the at least one spatially adjacent texel, the spatially adjacent texel with the minimum second angle, thereby improving search accuracy of the second seam texel.

In an embodiment, as shown in FIG. 4, the computer device may perform self-occlusion judgment on each texel in the initial three-dimensional mesh model. In some examples, for each texel in the initial three-dimensional mesh model, in the three-dimensional virtual scene, the texel is ignored if an occlusion mesh patch exists within a preset range along a normal direction of the texel from the texel, and texels not ignored in the initial three-dimensional mesh model are taken as sampled texels. For each sampled texel in the initial three-dimensional mesh model in the three-dimensional virtual scene, the computer device may construct a ray emission region perpendicular to a normal direction of the sampled texel, construct at least one ray (i.e., a ray bundle) by taking a point in the ray emission region as a ray starting point and taking a direction opposite to the normal direction of the sampled texel as a ray direction, and determine texels in the initial three-dimensional mesh model that intersect any one of the at least one ray, to obtain at least one candidate texel. Whether the sampled texel has a spatially adjacent texel is determined by using a world space adjacency discriminator. If at least one spatially adjacent texel of the sampled texel exists in the at least one candidate texel, the sampled texel is determined as the first seam texel. Then, the computer device may determine, from the spatially adjacent texel, the second seam texel having the seam adjacency relationship with the first seam texel respectively by using a normal angle discriminator, a same-plane discriminator, a spatial distance discriminator and an edge normal discriminator. In some examples, firstly, the computer device may select, by using the normal angle discriminator from the at least one spatially adjacent texel according to the illumination difference between the illumination data of the spatially adjacent texel and the illumination data of the first seam texel, the spatially adjacent texel meeting the target condition. Then, the computer device may select, by using the same-plane discriminator from the spatially adjacent texel selected based on the illumination difference, the spatially adjacent texel meeting the target condition according to the plane difference between the mesh patch where the spatially adjacent texel is located and the mesh patch where the first seam texel is located. Further, the computer device may select, by using the spatial distance discriminator from the spatially adjacent texel selected based on the plane difference, the spatially adjacent texel meeting the target condition according to the spatial distance between the spatially adjacent texel and the first seam texel in the three-dimensional virtual scene. Finally, the computer device may select, by using the edge normal discriminator from the spatially adjacent texel selected based on the spatial distance, one spatially adjacent texel as the second seam texel according to the intersection area between the coverage region of the spatially adjacent texel in the initial three-dimensional mesh model and the coverage region of the first seam texel in the initial three-Docket dimensional mesh model. The first seam texel and the second seam texel may be outputted as a seam texel pair, so as to facilitate subsequent model seam repair based on the outputted seam texel pair.

In an embodiment, the initial three-dimensional mesh model has a corresponding initial illumination map; and the repairing the first seam texel and the second seam texel in the initial three-dimensional mesh model, to obtain a target three-dimensional mesh model after seam repair includes: determining, from the initial illumination map, a texel mapped to each of the first seam texel and the second seam texel as a to-be-repaired seam texel; determining, for each of the to-be-repaired seam texels, a denoising reference region corresponding to the to-be-repaired seam texel in the initial illumination map according to the to-be-repaired seam texel and a seam texel having the seam adjacency relationship with the to-be-repaired seam texel in the initial illumination map; determining, according to an angle between an edge normal of each reference texel in the denoising reference region and an edge normal of the to-be-repaired seam texel, an illumination contribution parameter corresponding to the reference texel; denoising and repairing, according to the illumination contribution parameters corresponding to the reference texels and illumination data recorded for the reference texels in the initial illumination map, illumination data recorded for the to-be-repaired seam texel in the initial illumination map, to obtain a target illumination map; and performing illumination rendering on the initial three-dimensional mesh model according to the target illumination map, to obtain the target three-dimensional mesh model after seam repair on the initial three-dimensional mesh model.

The initial illumination map is an illumination map corresponding to the initial three-dimensional mesh model. The initial illumination map is an illumination map before denoising and repairing. Each of the first seam texel and the second seam texel refers to any texel in the first seam texel and the second seam texel. The to-be-repaired seam texel is a to-be-repaired seam texel in the initial illumination map. The denoising reference region is a region used as a reference during the denoising and repairing for the to-be-repaired seam texel. The denoising reference region includes at least one reference texel. The reference texel is a texel used as a reference during the denoising for the to-be-repaired seam texel. The edge normal of the reference texel is a direction vector of a perpendicular line between an edge of the reference texel and an opposite mesh vertex in a mesh patch. A direction of the edge normal of the reference texel is from the edge of the reference texel to the opposite mesh vertex. The edge normal of the to-be-repaired seam texel is a direction vector of a perpendicular line between an edge of the to-be-repaired seam texel and an opposite mesh vertex in a mesh patch. A direction of the edge normal of the to-be-repaired seam texel is from the edge of the to-be-repaired seam texel to the opposite mesh vertex. The illumination contribution parameter is a parameter configured for representing an illumination contribution of the reference texel to the to-be-repaired seam texel. The target illumination map is an illumination map after denoising and repairing.

In some examples, the computer device may determine, from the initial illumination map, a texel mapped to each of the first seam texel and the second seam texel as a to-be-repaired seam texel. Each of the first seam texel and the second seam texel is a seam texel in the initial three-dimensional mesh model in a three-dimensional space, and the to-be-repaired seam texel is a seam texel in an initial illumination map in a two-dimensional space. Each of the first seam texel and the second seam texel in the three-dimensional space has a mapping relationship with the to-be-repaired seam texel in the two-dimensional space. For each to-be-repaired seam texel, the computer device may determine a denoising reference region corresponding to the to-be-repaired seam texel in the initial illumination map according to the to-be-repaired seam texel and a seam texel having the seam adjacency relationship with the to-be-repaired seam texel in the initial illumination map. The first seam texel and the second seam texel are a seam texel pair in the initial three-dimensional mesh model, and the to-be-repaired seam texel and a corresponding seam texel having the seam adjacency relationship therewith are also a seam texel pair in the initial illumination map. The computer device may determine, according to the angle between the edge normal of each reference texel in the denoising reference region and the edge normal of the to-be-repaired seam texel, an illumination contribution parameter of the reference texel for the to-be-repaired seam texel, and denoise and repair, according to the illumination contribution parameters corresponding to the reference texels for the to-be-repaired seam texel and the illumination data recorded for the reference texels in the initial illumination map, the illumination data recorded for the to-be-repaired seam texel in the initial illumination map, to obtain the target illumination map. Then, the computer device may perform illumination rendering on the initial three-dimensional mesh model according to the target illumination map, to obtain the target three-dimensional mesh model after seam repair on the initial three-dimensional mesh model.

In an embodiment, the determining, for each of the to-be-repaired seam texels, a denoising reference region corresponding to the to-be-repaired seam texel in the initial illumination map according to the to-be-repaired seam texel and a seam texel having the seam adjacency relationship with the to-be-repaired seam texel in the initial illumination map includes: determining, for each of the to-be-repaired seam texels, the denoising reference region corresponding to the to-be-repaired seam texel in this round of denoising and repairing in the initial illumination map according to the to-be-repaired seam texel and the seam texel having the seam adjacency relationship with the to-be-repaired seam texel in the initial illumination map. The method further includes: taking an illumination map after this round of denoising and repairing as an initial illumination map for a next round of denoising and repair, taking the next round as a new round, and determining, for each to-be-repaired seam texel according to the to-be-repaired seam texel and the seam texel having the seam adjacency relationship with the to-be-repaired seam texel in the initial illumination map, the denoising reference region corresponding to the to-be-repaired seam texel in this round of denoising and repairing in the initial illumination map to iterate denoising and repair until an iteration stop condition is met, to obtain the target illumination map. In this embodiment, by performing multiple rounds of denoising and repairing on the initial illumination map, the model seam repair effect is further improved, thereby further improving the model rendering quality.

In an embodiment, in each round of denoising and repairing, a distance between any two adjacent sampling points in a filter kernel used in this round is greater than a distance between any two adjacent sampling points in a previous round. In this way, by iterating denoising and repair multiple rounds, a sampling range of the filter kernel can gradually cover the entire illumination map, achieving a large-range filtering sampling, and illumination information of each reference texel in the illumination map can be more fully utilized, thereby further improving the model seam repair effect.

In an embodiment, for each to-be-repaired seam texel, the computer device may determine the denoising reference region corresponding to the to-be-repaired seam texel in the initial illumination map according to a texel adjacent to the to-be-repaired seam texel in the initial illumination map and a texel adjacent to the seam texel having the seam adjacency relationship with the to-be-repaired seam texel in the initial illumination map. The denoising reference region includes the to-be-repaired seam texel, the texel adjacent to the to-be-repaired seam texel in the initial illumination map, the seam texel having the seam adjacency relationship with the to-be-repaired seam texel, and the texel adjacent to the seam texel having the seam adjacency relationship with the to-be-repaired seam texel in the initial illumination map.

In an embodiment, the computer device may denoise and repair, according to the illumination contribution parameters corresponding to the reference texels and the illumination data recorded for the reference texels in the initial illumination map, the illumination data recorded for the to-be-repaired seam texel in the initial illumination map, to obtain denoised illumination data corresponding to the to-be-repaired seam texel, and directly write the denoised illumination data back to the initial illumination map, to obtain the target illumination map. The denoised illumination data corresponding to the to-be-repaired seam texel may cover the illumination data recorded for the to-be-repaired seam texel in the initial illumination map.

In an embodiment, the computer device may denoise and repair, according to the illumination contribution parameters corresponding to the reference texels and the illumination data recorded for the reference texels in the initial illumination map, the illumination data recorded for the to-be-repaired seam texel in the initial illumination map, to obtain the denoised illumination map after denoising and repair, and directly take the denoised illumination map as the target illumination map.

In an embodiment, by determining the denoising reference region corresponding to the to-be-repaired seam texel in the initial illumination map according to the to-be-repaired seam texel and the seam texel having the seam adjacency relationship with the to-be-repaired seam texel in the initial illumination map, accuracy of the denoising reference region can be improved. The angle between the edge normal of the reference texel and the edge normal of the to-be-repaired seam texel is inversely proportional to the illumination contribution of the reference texel to the to-be-repaired seam texel. Therefore, accuracy of the illumination contribution parameter can be improved by determining, according to the angle between the edge normal of each reference texel in the denoising reference region and the edge normal of the to-be-repaired seam texel, the illumination contribution parameter corresponding to the reference texel. Then, the to-be-repaired seam texel in the initial illumination map is denoised and repaired based on the more accurate illumination contribution parameter, thereby performing illumination rendering on the initial three-dimensional mesh model based on a denoised target illumination map, which can improve rendering quality of the target three-dimensional mesh model after seam repair.

In an embodiment, the determining a denoising reference region corresponding to the to-be-repaired seam texel in the initial illumination map according to the to-be-repaired seam texel and a seam texel having the seam adjacency relationship with the to-be-repaired seam texel in the initial illumination map includes: determining, along a direction of the edge normal of the to-be-repaired seam texel, a first sampling range of a filter kernel configured for denoising and repairing; determining, along a direction of an edge normal of an adjacent seam texel, a second sampling range of the filter kernel; the adjacent seam texel being a seam texel having the seam adjacency relationship with the to-be-repaired seam texel; and determining the denoising reference region corresponding to the to-be-repaired seam texel in the initial illumination map according to the first sampling range and the second sampling range.

The first sampling range and the second sampling range of the filter kernel are respectively sampling ranges of the filter kernel that meet a target condition. The first sampling range and the second sampling range of the filter kernel jointly form a sampling range of the filter kernel.

In some examples, the computer device may determine, along the direction of the edge normal of the to-be-repaired seam texel, the first sampling range of the filter kernel configured for denoising and repairing, and determine, along the direction of the edge normal of the adjacent seam texel, the second sampling range of the filter kernel. The adjacent seam texel is a seam texel having the seam adjacency relationship with the to-be-repaired seam texel. Then, the computer device may take the first sampling range and the second sampling range together as the sampling range of the filter kernel, and determine the denoising reference region corresponding to the to-be-repaired seam texel in the initial illumination map according to the sampling range of the filter kernel. The reference texels included in the denoising reference region are texels covered by the sampling range of the filter kernel in the initial illumination map.

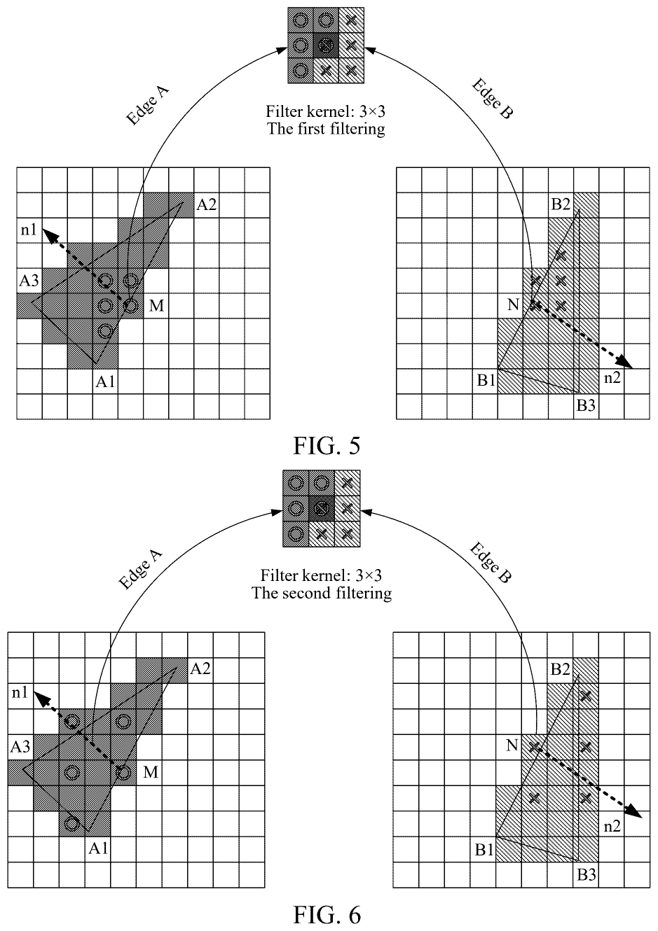

In an embodiment, the computer device may denoise and repair the to-be-repaired seam texel in the initial illumination map multiple rounds (e.g., two rounds). In each round of denoising and repairing, a distance between any two adjacent sampling points in a filter kernel used in this round is greater than a distance between any two adjacent sampling points in a previous round. For example, as shown in FIG. 5, the filter kernel configured for denoising and repairing is a 3×3 filter kernel. In the first round of denoising and repairing (the first filtering), the computer device may determine, along a direction of an edge normal n1 of a to-be-repaired seam texel (i.e., a point M on an edge A(A1A2) of a triangular mesh patch A1A2A3), the first sampling range of the filter kernel configured for denoising and repairing (i.e., sampling points of 5 circles in the triangular mesh patch A1A2A3). The computer device may determine, along a direction of an edge normal n2 of an adjacent seam texel (i.e., a point N on an edge B (B1B2) of a triangular mesh patch B1B2B3), the second sampling range of the filter kernel (i.e., sampling points of 5 crosses in the triangular mesh patch B1B2B3). Then, the computer device may determine the denoising reference region (i.e., the 5 circles in the triangular mesh patch A1A2A3 and the 5 crosses in the triangular mesh patch B1B2B3) corresponding to the to-be-repaired seam texel in the initial illumination map according to the first sampling range and the second sampling range.

In an embodiment, as shown in FIG. 6, in the second round of denoising and repairing (the second filtering), a distance between any two adjacent sampling points in a filter kernel used in the second round of denoising and repairing is greater than a distance between any two adjacent sampling points in the first round. Compared with the distance between any two adjacent sampling points in FIG. 5, the distance between any two adjacent sampling points in FIG. 6 is larger, and compared with the first round of denoising and repair, the filter kernel has a wider filtering range in the second round of denoising and repair, which further improves the model seam repair effect, thereby improving the model rendering quality.

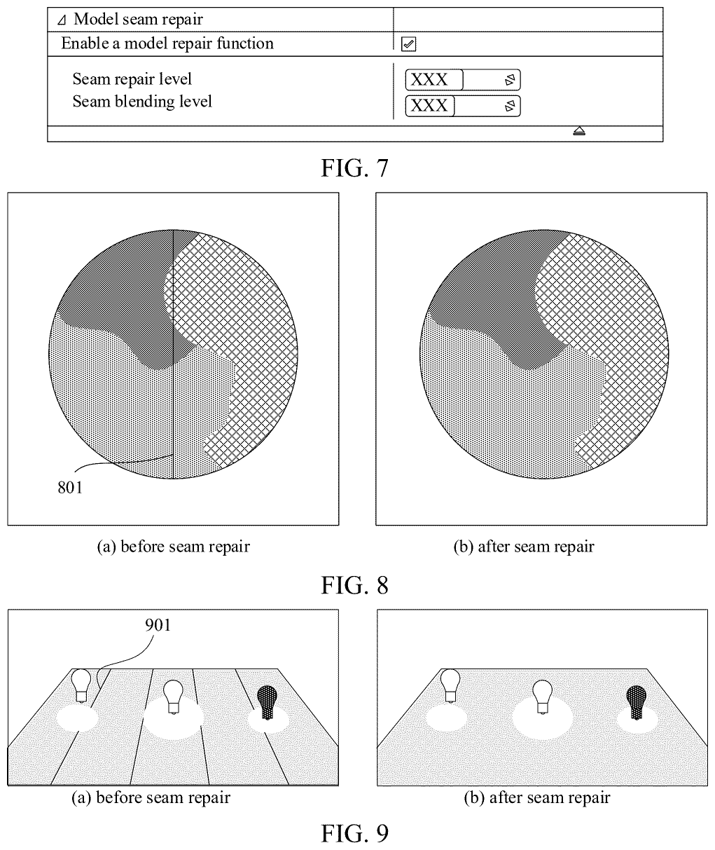

In an embodiment, FIG. 7 shows an interface corresponding to the computer device and configured for configuring parameters involved during denoising and repairing (i.e., model seam repair). Model seam repair may be enabled by checking “Enable a model repair function” on the parameter configuration interface. A parameter “Seam repair level” may be configured for configuring the sampling range of the filter kernel and a quantity of times of iteration of multiple rounds of denoising and repairing.

In the above embodiments, the direction of the texel edge normal is consistent with a direction of an inner side of the mesh patch where the illumination data is recorded. Therefore, by determining the first sampling range along the direction of the edge normal of the to-be-repaired seam texel and determining the second sampling range along the direction of the edge normal of the adjacent seam texel, sampling of invalid texels, i.e., texels in the illumination map for which no illumination data is recorded, can be prevented. Then, the denoising reference region corresponding to the to-be-repaired seam texel in the initial illumination map is determined according to the first sampling range and the second sampling range, which can improve accuracy of the denoising reference region.

In an embodiment, the denoising and repairing, according to the illumination contribution parameters corresponding to the reference texels and illumination data recorded for the reference texels in the initial illumination map, illumination data recorded for the to-be-repaired seam texel in the initial illumination map, to obtain a target illumination map includes: denoising and repairing, according to the illumination contribution parameters corresponding to the reference texels and the illumination data recorded for the reference texels in the initial illumination map, the illumination data recorded for the to-be-repaired seam texel in the initial illumination map, to obtain denoised illumination data corresponding to the to-be-repaired seam texel; blending the denoised illumination data corresponding to the to-be-repaired seam texel with illumination data before denoising, to obtain blended illumination data corresponding to the to-be-repaired seam texel; and writing the blended illumination data respectively corresponding to the to-be-repaired seam texels back to the initial illumination map, to obtain the target illumination map.

The blended illumination data is illumination data obtained after the denoised illumination data corresponding to the to-be-repaired seam texel is blended with the illumination data before denoising. Both the denoised illumination data corresponding to the to-be-repaired seam texel and the illumination data before denoising corresponding to the to-be-repaired seam texel are taken into account in the blended illumination data.

In an embodiment, the computer device may denoise and repair, according to the illumination contribution parameters corresponding to the reference texels and the illumination data recorded for the reference texels in the initial illumination map, the illumination data recorded for the to-be-repaired seam texel in the initial illumination map, to obtain denoised illumination data corresponding to the to-be-repaired seam texel. The computer device may acquire a blending coefficient for the denoised illumination data corresponding to the to-be-repaired seam texel, and blend the denoised illumination data corresponding to the to-be-repaired seam texel with the illumination data before denoising based on the blending coefficient for the denoised illumination data corresponding to the to-be-repaired seam texel, to obtain the blended illumination data corresponding to the to-be-repaired seam texel. Then, the computer device may write the blended illumination data corresponding to each to-be-repaired seam texel back to the initial illumination map, to obtain the target illumination map. Still referring to FIG. 7, a parameter “Seam blending level” parameter may be configured for configuring the blending coefficient for blending illumination data corresponding to texels.

In an embodiment, the blending coefficient for the denoised illumination data corresponding to the to-be-repaired seam texel may be taken as a blending weight for the denoised illumination data corresponding to the to-be-repaired seam texel, and the denoised illumination data corresponding to the to-be-repaired seam texel is blended with the illumination data before denoising based on the blending coefficient, to obtain the blended illumination data corresponding to the to-be-repaired seam texel. For example, if the blending coefficient (the blending weight) for the denoised illumination data corresponding to the to-be-repaired seam texel is a, a blending coefficient for the illumination data before denoising corresponding to the to-be-repaired seam texel is (1-a).

In an embodiment, the computer device may write the blended illumination data corresponding to each to-be-repaired seam texel back to the initial illumination map, to obtain a blended illumination map, and directly take the blended illumination map as the target illumination map. The blended illumination map is an illumination map obtained after the blended illumination data respectively corresponding to the to-be-repaired seam texels is written back to the initial illumination map. The blended illumination data corresponding to each to-be-Docket repaired seam texel may cover the illumination data recorded for each to-be-repaired seam texel in the initial illumination map, to obtain the blended illumination map.

In the above embodiments, a difference between the denoised illumination data corresponding to the to-be-repaired seam texel and illumination data corresponding to secondary texels is excessively large. Therefore, by blending the denoised illumination data corresponding to the to-be-repaired seam texel with illumination data before denoising to obtain the blended illumination data corresponding to the to-be-repaired seam texel, the difference between the denoised illumination data corresponding to the to-be-repaired seam texel and the illumination data corresponding to the secondary texels can be reduced. Then, by writing the blended illumination data respectively corresponding to the to-be-repaired seam texels back to the initial illumination map to obtain the target illumination map, the rendering quality of the target three-dimensional mesh model after seam repair based on the target illumination map can be further improved.

In an embodiment, the writing the blended illumination data respectively corresponding to the to-be-repaired seam texels back to the initial illumination map, to obtain the target illumination map includes: writing the blended illumination data respectively corresponding to the to-be-repaired seam texels back to the initial illumination map, to obtain a blended illumination map; determining, along a direction of the edge normal of the to-be-repaired seam texel, a secondary texel adjacent to the to-be-repaired seam texel from the blended illumination map; and blending illumination data recorded for the secondary texel in the blended illumination map with illumination data recorded for an adjacent seam texel in the blended illumination map, to obtain the target illumination map; the adjacent seam texel being a seam texel having the seam adjacency relationship with the to-be-repaired seam texel.

In an embodiment, the secondary texel is a texel adjacent to the to-be-repaired seam texel in the illumination map. The computer device may write the blended illumination data corresponding to each to-be-repaired seam texel back to the initial illumination map, to obtain the blended illumination map. Then, the computer device may determine, along the direction of the edge normal of the to-be-repaired seam texel, the secondary texel adjacent to the to-be-repaired seam texel from the blended illumination map, acquire a blending coefficient for the secondary texel, and blend, based on the blending coefficient for the secondary texel, the illumination data recorded for the secondary texel in the blended illumination map with the illumination data recorded for the adjacent seam texel in the blended illumination map, to obtain the target illumination map. The adjacent seam texel is a seam texel having the seam adjacency relationship with the to-be-repaired seam texel.

In the above embodiments, a difference between the blended illumination data corresponding to the to-be-repaired seam texel and the illumination data corresponding to the secondary texel is excessively large, which may cause a seam to change from a dark-colored thin seam to a light-colored seam strip. Therefore, by blending the illumination data recorded for the secondary texel in the blended illumination map with the illumination data recorded for the adjacent seam texel in the blended illumination map to obtain the target illumination map, the difference between the blended illumination data corresponding to the to-be-repaired seam texel and the illumination data corresponding to the secondary texel can be reduced, thereby further improving the rendering quality of the target three-dimensional mesh model after seam repair based on the target illumination map.

In an embodiment, the denoising and repairing, according to the illumination contribution parameters corresponding to the reference texels and illumination data recorded for the reference texels in the initial illumination map, illumination data recorded for the to-be-repaired seam texel in the initial illumination map, to obtain a target illumination map includes: denoising and repairing, according to the illumination contribution parameters corresponding to the reference texels and the illumination data recorded for the reference texels in the initial illumination map, the illumination data recorded for the to-be-repaired seam texel in the initial illumination map, to obtain a denoised illumination map; for each of the to-be-repaired seam texels, determining, from the denoised illumination map, an unmapped texel adjacent to the to-be-repaired seam texel and having no illumination data recorded therefor; and filling the unmapped texel with illumination data recorded for an adjacent seam texel in the denoised illumination map, to obtain the target illumination map; the adjacent seam texel being a seam texel having the seam adjacency relationship with the to-be-repaired seam texel.

The denoised illumination map is an illumination map obtained after the illumination data recorded for the to-be-repaired seam texel in the initial illumination map is denoised and repaired. The unmapped texel is a texel in the illumination map and having no mapping relationship with the texel in the three-dimensional mesh model. No illumination data is recorded in the unmapped texel.

In some examples, the computer device may denoise and repair, according to the illumination contribution parameters corresponding to the reference texels and the illumination data recorded for the reference texels in the initial illumination map, the illumination data recorded for the to-be-repaired seam texel in the initial illumination map, to obtain the denoised illumination map. For each to-be-repaired seam texel, the computer device may determine, from the denoised illumination map, an unmapped texel adjacent to the to-be-repaired seam texel and having no illumination data recorded therefor. Then, the computer device may fill the unmapped texel with illumination data recorded for an adjacent seam texel in the denoised illumination map, to obtain the target illumination map. The adjacent seam texel is a seam texel having the seam adjacency relationship with the to-be-repaired seam texel. After the filling, illumination data is also recorded for the unmapped texel in the target illumination map.

In an embodiment, for each unmapped texel, in a case that the unmapped texel is adjacent to a plurality of to-be-repaired seam texels, the computer device may determine edge normals of the to-be-repaired seam texels respectively. For each unmapped texel, the unmapped texel is filled with illumination data, for example by using an adjacent seam texel of a to-be-repaired seam texel opposite to the unmapped texel. If the unmapped texel does not have a to-be-repaired seam texel opposite to the unmapped texel, the unmapped texel is filled with illumination data by using an adjacent seam texel of a to-be-repaired seam texel at 45 degrees to the unmapped texel.

In the above embodiments, when illumination rendering is performed on the initial three-dimensional mesh model according to the target illumination map, the illumination data in the target illumination map is sampled by interpolation sampling (i.e., each sampling of illumination data may refer to illumination data recorded for a plurality of adjacent texels). Therefore, the unmapped texel is filled with illumination data recorded for the adjacent seam texel in the denoised illumination map, to obtain the target illumination map, which can prevent sampling of texels for which no illumination data is recorded during interpolation sampling, thereby further improving the model rendering quality.

In an embodiment, the determining, according to an angle between an edge normal of each reference texel in the denoising reference region and an edge normal of the to-be-repaired seam texel, an illumination contribution parameter corresponding to the reference texel includes: for each reference texel in the denoising reference region, determining a first normal influence parameter according to the angle between the edge normal of the reference texel and the edge normal of the to-be-repaired seam texel; and determining the illumination contribution parameter corresponding to the reference texel according to at least one of the first normal influence parameter, a second normal influence parameter, a distance influence parameter, and a brightness influence parameter; where the second normal influence parameter is configured for representing a degree of influence of a normal of the to-be-repaired seam texel in the three-dimensional virtual scene and a normal of the reference texel in the three-dimensional virtual scene on the illumination contribution; the distance influence parameter is configured for representing a degree of influence of a distance between the to-be-repaired seam texel and the reference texel in the three-dimensional virtual scene on the illumination contribution; and the brightness influence parameter is configured for representing a degree of influence of brightness of the to-be-repaired seam texel and brightness of the reference texel on the illumination contribution.

The first normal influence parameter is configured for representing a degree of influence of an angle between the edge normal of the reference texel and the edge normal of the to-be-repaired seam texel on the illumination contribution. The second normal influence parameter is determined according to the normal of the to-be-repaired seam texel in the three-dimensional virtual scene and the normal of the reference texel in the three-dimensional virtual scene. The distance influence parameter is determined according to the distance between the to-be-repaired seam texel and the reference texel in the three-dimensional virtual scene. The brightness influence parameter is determined according to the brightness of the to-be-repaired seam texel and the brightness of the reference texel.

In an embodiment, for each reference texel in the denoising reference region, the computer device may select a maximum value from zero and a first dot product result as the first normal influence parameter. The first dot product result is a vector dot product result between an edge normal vector of the reference texel and an edge normal vector of the to-be-repaired seam texel. The first dot product result is negatively correlated with the angle between the edge normal of the reference texel and the edge normal of the to-be-repaired seam texel.

In an embodiment, for each reference texel in the denoising reference region, the computer device may select a maximum value from zero and a second dot product result as the second normal influence parameter. The second dot product result is a vector dot product result between a normal vector of the reference texel in the three-dimensional virtual scene and a normal vector of the to-be-repaired seam texel in the three-dimensional virtual scene.

In an embodiment, the computer device may denoise and repair the illumination data recorded for the to-be-repaired seam texel by using the following formulas.

$${\hat{c}}_{i + 1} ( p ) = \frac{{\sum }_{q ∈ Ω} {w}_{i} ( p , q ) \cdot {\hat{c}}_{i} ( q )}{{\sum }_{q ∈ Ω} w ( p , q )} ;$$

$${w}_{i} ( p , q ) = {w}_{p} \cdot {w}_{n} \cdot {w}_{l} \cdot {w}_{{n}^{′}} ;$$

$${w}_{P} = exp ( - \frac{\vert P ( p ) - P ( q ) \vert}{{σ}_{P} \vert ∇ P ( p ) \cdot ( p - q ) \vert + ε} ) ;$$

$${w}_{n} = {max ( 0 , n ( p ) \cdot n ( q ) )}^{{σ}_{n}} ;$$

$${w}_{l} = exp ( - \frac{\vert {l}_{i} ( p ) - {l}_{i} ( q ) \vert}{{\sqrt[{σ}_{l}]{{g}_{3 \times 3} ( Var ( {l}_{i} ( p ) ) )}}^{+ ε}} ) ;$$

$$and$$

$${w}_{{n}^{′}} = {max ( 0 , {n}^{′} ( p ) \cdot {n}^{′} ( q ) )}^{{σ}_{{n}^{′}}}$$

where p denotes the to-be-repaired seam texel, q denotes the reference texel, Ω denotes the denoising reference region, i denotes a previous round of denoising and repairing, i+1 denotes this round of denoising and repairing, σₚ, σₙ, σₗ, σ_{n′}, and ε are present constants, P(p) denotes a position of the to-be-repaired seam texel in the three-dimensional space, |P(p)−P(q)| denotes a world space distance between a position of the reference texel in the three-dimensional space and the position of the to-be-repaired seam texel in the three-dimensional space, n(p) denotes the normal vector of the to-be-repaired seam texel in the three-dimensional virtual scene, n(q) denotes the normal vector of the reference texel in the three-dimensional virtual scene, lᵢ(p) denotes a brightness value of the to-be-repaired seam texel after the previous round of denoising and repairing, lᵢ(q) denotes a brightness value of the reference texel after the previous round of denoising and repairing, Var denotes a variance function, and q_{3×3} denotes a 3*3 Gaussian function. n′(p) denotes the edge normal vector of the to-be-repaired seam texel, and n′(q) denotes the edge normal vector of the reference texel. wₚ denotes the distance influence parameter, p_{n′} denotes the first normal influence parameter, wₙ denotes the second normal influence parameter, wₗ denotes the brightness influence parameter, wᵢ(p,q) denotes an illumination contribution parameter of the reference texel for the to-be-repaired seam texel after the previous round of denoising and repairing, ĉ(q) denotes illumination data (for example, the illumination data may be a color value or other illumination data other than the color value) recorded for the reference texel in the illumination map after the previous round of denoising and repairing, and ĉᵢ₊₁(p) denotes illumination data recorded for the to-be-repaired seam texel in the illumination map after this round of denoising and repairing.

In the above embodiments, the illumination contribution parameter corresponding to the reference texel is determined according to at least one of the first normal influence parameter, the second normal influence parameter, the distance influence parameter, and the brightness influence parameter, which can further improve the accuracy of the illumination contribution parameter, thereby further improving the model rendering quality.

In an embodiment, as shown in FIG. 8, (a) is a schematic diagram of an initial three-dimensional mesh model before seam repair. As can be seen, in (a), there is a clear seam defect 801 in the initial three-dimensional mesh model, which results in low model rendering quality. A target three-dimensional mesh model after seam repair in (b) may be obtained by performing seam repair on the initial three-dimensional mesh model by using the model seam repairing method in this disclosure. As can be seen, in (b), there are no seam defects in the target three-dimensional mesh model, which improves the model rendering quality.

In an embodiment, as shown in FIG. 9, (a) is a schematic diagram of a plurality of continuous initial three-dimensional mesh models (e.g., 5 three-dimensional mesh models in FIG. 9) in a three-dimensional virtual scene before seam repair. As can be seen, in (a), there are clear seam defects 901 in regions where the plurality of initial three-dimensional mesh models are connected, thereby resulting in low rendering quality of a plurality of continuous models in the three-dimensional virtual scene. A plurality of continuous target three-dimensional mesh models in the three-dimensional virtual scene after seam repair in (b) may be obtained by performing seam repair on the plurality of continuous initial three-dimensional mesh models in the three-dimensional virtual scene by using the model seam repairing method in this disclosure. As can be seen, in (b), there are no seam defects in the plurality of continuous target three-dimensional mesh models in the three-dimensional virtual scene, which improves the rendering quality of the plurality of continuous models in the three-dimensional virtual scene.

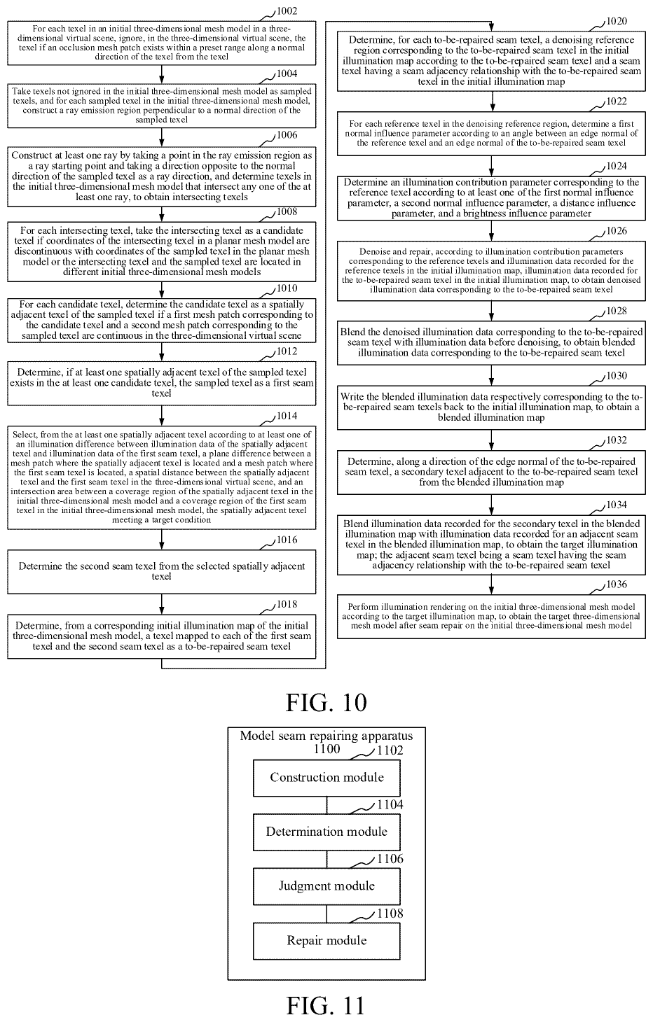

As shown in FIG. 10, in an embodiment, a model seam repairing method is provided. The method may be applied to a computer device. The computer device may be a terminal or a server. The method may be performed by the terminal or the server alone, or may be implemented through interaction between the terminal and the server. This embodiment is described by using an example in which the method is applied to a computer device. In some examples, the method includes the following operations:
Operation 1002: For each texel in an initial three-dimensional mesh model in a three-dimensional virtual scene, ignore, in the three-dimensional virtual scene, the texel if an occlusion mesh patch exists within a preset range along a normal direction of the texel from the texel.
Operation 1004: Take texels not ignored in the initial three-dimensional mesh model as sampled texels, and for each sampled texel in the initial three-dimensional mesh model, construct a ray emission region perpendicular to a normal direction of the sampled texel.
Operation 1006: Construct at least one ray by taking a point in the ray emission region as a ray starting point and taking a direction opposite to the normal direction of the sampled texel as a ray direction, and determine texels in the initial three-dimensional mesh model that intersect any one of the at least one ray, to obtain intersecting texels.
Operation 1008: For each intersecting texel, take the intersecting texel as a candidate texel if coordinates of the intersecting texel in a planar mesh model are discontinuous with coordinates of the sampled texel in the planar mesh model or the intersecting texel and the sampled texel are located in different initial three-dimensional mesh models.
Operation 1010: For each candidate texel, determine the candidate texel as a spatially adjacent texel of the sampled texel if a first mesh patch corresponding to the candidate texel and a second mesh patch corresponding to the sampled texel are continuous in the three-dimensional virtual scene.
Operation 1012: Determine, if at least one spatially adjacent texel of the sampled texel exists in the at least one candidate texel, the sampled texel as a first seam texel.
Operation 1014: Select, from the at least one spatially adjacent texel according to at least one of an illumination difference between illumination data of the spatially adjacent texel and illumination data of the first seam texel, a plane difference between a mesh patch where the spatially adjacent texel is located and a mesh patch where the first seam texel is located, a spatial distance between the spatially adjacent texel and the first seam texel in the three-dimensional virtual scene, and an intersection area between a coverage region of the spatially adjacent texel in the initial three-dimensional mesh model and a coverage region of the first seam texel in the initial three-dimensional mesh model, the spatially adjacent texel meeting a target condition.
Operation 1016: Determine the second seam texel from the selected spatially adjacent texel.
Operation 1018: Determine, from a corresponding initial illumination map of the initial three-dimensional mesh model, a texel mapped to each of the first seam texel and the second seam texel as a to-be-repaired seam texel.
Operation 1020: Determine, for each to-be-repaired seam texel, a denoising reference region corresponding to the to-be-repaired seam texel in the initial illumination map according to the to-be-repaired seam texel and a seam texel having a seam adjacency relationship with the to-be-repaired seam texel in the initial illumination map.
Operation 1022: For each reference texel in the denoising reference region, determine a first normal influence parameter according to the angle between an edge normal of the reference texel and an edge normal of the to-be-repaired seam texel.
Operation 1024: Determine an illumination contribution parameter corresponding to the reference texel according to at least one of the first normal influence parameter, a second normal influence parameter, a distance influence parameter, and a brightness influence parameter.
Operation 1026: Denoise and repair, according to illumination contribution parameters corresponding to the reference texels and illumination data recorded for the reference texels in the initial illumination map, illumination data recorded for the to-be-repaired seam texel in the initial illumination map, to obtain denoised illumination data corresponding to the to-be-repaired seam texel.
Operation 1028: Blend the denoised illumination data corresponding to the to-be-repaired seam texel with illumination data before denoising, to obtain blended illumination data corresponding to the to-be-repaired seam texel.
Operation 1030: Write the blended illumination data respectively corresponding to the to-be-repaired seam texels back to the initial illumination map, to obtain a blended illumination map.
Operation 1032: Determine, along a direction of the edge normal of the to-be-repaired seam texel, a secondary texel adjacent to the to-be-repaired seam texel from the blended illumination map.
Operation 1034: Blend illumination data recorded for the secondary texel in the blended illumination map with illumination data recorded for an adjacent seam texel in the blended illumination map, to obtain the target illumination map; the adjacent seam texel being a seam texel having the seam adjacency relationship with the to-be-repaired seam texel.
Operation 1036: Perform illumination rendering on the initial three-dimensional mesh model according to the target illumination map, to obtain the target three-dimensional mesh model after seam repair on the initial three-dimensional mesh model.

This disclosure further provides an application scene. The foregoing model seam repairing method is applied to the application scene. In some examples, the model seam repairing method may be applied to seam repair scenes of game models in a game field.

The three-dimensional virtual scene includes a game scene, the initial three-dimensional mesh model includes an initial game model, and the target three-dimensional mesh model includes a target game model. A game model in the game scene may have a seam effect. Seam repair may be performed on the game model in the game scene by using the model seam repairing method in this disclosure. For example, the game model may include at least one of a virtual table, a virtual chair, a virtual desk lamp, and the like in the game scene. Seam repair may be performed on the virtual table, the virtual chair, the virtual desk lamp, and the like by using the model seam repairing method in this disclosure, which improves rendering quality of the game model in the game scene.

In some examples, for each texel in the initial game model in the game scene, in the game scene, the computer device may ignore the texel if an occlusion mesh patch exists within a preset range along a normal direction of the texel from the texel. Texels not ignored in the initial game model are taken as sampled texels, and for each sampled texel in the initial game model, a ray emission region perpendicular to a normal direction of the sampled texel is constructed. At least one ray is constructed by taking a point in the ray emission region as a ray starting point and taking a direction opposite to the normal direction of the sampled texel as a ray direction, and texels in the initial game model that intersect any one of the at least one ray are determined, to obtain intersecting texels. For each intersecting texel, the intersecting texel is taken as a candidate texel if coordinates of the intersecting texel in a planar mesh model are discontinuous with coordinates of the sampled texel in the planar mesh model or the intersecting texel and the sampled texel are located in different initial game models. For each candidate texel, the candidate texel is determined as a spatially adjacent texel of the sampled texel if a first mesh patch corresponding to the candidate texel and a second mesh patch corresponding to the sampled texel are continuous in the game scene. If at least one spatially adjacent texel of the sampled texel exists in the at least one candidate texel, the sampled texel is determined as the first seam texel.

The computer device may select, from the at least one spatially adjacent texel according to at least one of an illumination difference between illumination data of the spatially adjacent texel and illumination data of the first seam texel, a plane difference between a mesh patch where the spatially adjacent texel is located and a mesh patch where the first seam texel is located, a spatial distance between the spatially adjacent texel and the first seam texel in the game scene, and an intersection area between a coverage region of the spatially adjacent texel in the initial game model and a coverage region of the first seam texel in the initial game model, the spatially adjacent texel meeting a target condition. The second seam texel is determined from the selected spatially adjacent texel.

The computer device may determine, from a corresponding initial illumination map of the initial game model, a texel mapped to each of the first seam texel and the second seam texel as a to-be-repaired seam texel. For each to-be-repaired seam texel, a denoising reference region corresponding to the to-be-repaired seam texel in the initial illumination map is determined according to the to-be-repaired seam texel and a seam texel having the seam adjacency relationship with the to-be-repaired seam texel in the initial illumination map. For each reference texel in the denoising reference region, a first normal influence parameter is determined according to an angle between an edge normal of the reference texel and an edge normal of the to-be-repaired seam texel. The illumination contribution parameter corresponding to the reference texel is determined according to at least one of the first normal influence parameter, a second normal influence parameter, a distance influence parameter, and a brightness influence parameter. The illumination data recorded for the to-be-repaired seam texel in the initial illumination map is denoised and repaired according to the illumination contribution parameters corresponding to the reference texels and the illumination data recorded for the reference texels in the initial illumination map, to obtain denoised illumination data corresponding to the to-be-repaired seam texel.

The computer device may blend the denoised illumination data corresponding to the to-be-repaired seam texel with illumination data before denoising, to obtain blended illumination data corresponding to the to-be-repaired seam texel. The blended illumination data corresponding to each to-be-repaired seam texel is written back to the initial illumination map, to obtain a blended illumination map. Along a direction of the edge normal of the to-be-repaired seam texel, a secondary texel adjacent to the to-be-repaired seam texel is determined from the blended illumination map. Illumination data recorded for the secondary texel in the blended illumination map is blended with illumination data recorded for an adjacent seam texel in the blended illumination map, to obtain the target illumination map. The adjacent seam texel is a seam texel having the seam adjacency relationship with the to-be-repaired seam texel. Illumination rendering is performed on the initial game model according to the target illumination map, to obtain the target game model after seam repair on the initial game model. Repair efficiency of the game model in the game scene and rendering quality of the game model can be improved by using the model seam repairing method in this disclosure.

This disclosure further provides some application scenes. The foregoing model seam repairing method is applied to the application scenes. In some examples, this disclosure may further be applied to scenes such as film and television special effects, visual design, VR, industrial simulation, and digital cultural creation. The scenes such as film and television special effects, visual design, VR, industrial simulation, and digital cultural creation may include a virtual object model, the initial three-dimensional mesh model includes an initial virtual model, and the target three-dimensional mesh model includes a target virtual model. Seam repair may be performed on the virtual object model by using the model seam repairing method in this disclosure, thereby improving rendering quality of the virtual object model.

This disclosure may be applied to industrial simulation scenes. The three-dimensional virtual scene includes an industrial simulation scene, the initial three-dimensional mesh model includes an initial industrial model, and the target three-dimensional mesh model includes a target industrial model. An industrial model in the industrial simulation scene may have a seam effect. Seam repair may be performed on the industrial model by using the model seam repairing method in this disclosure, thereby improving rendering quality of the industrial model in the industrial simulation scene.

Although the steps in the flowcharts of the embodiments are displayed sequentially according to a sequence, these steps are not necessarily performed sequentially according to the sequence. Unless otherwise explicitly specified herein, execution of the steps is not strictly limited, and the steps may be performed in other sequences. Moreover, at least some of the steps in each embodiment may include a plurality of sub-steps or a plurality of stages. The sub-steps or stages are not necessarily performed at the same moment but may be performed at different moments. Execution of the sub-steps or stages is not necessarily sequentially performed, but may be performed in turn or alternately with other steps or at least some of sub-steps or stages of other steps.

In an embodiment, as shown in FIG. 11, a model seam repairing apparatus 1100 is provided. In some examples, the apparatus includes:
a construction module 1102, configured to determine sampled texels obtained by sampling texels of an initial three-dimensional mesh model in a three-dimensional virtual scene, and for each of the sampled texels, construct a ray emission region perpendicular to a normal direction of the sampled texel;
a determination module 1104, configured to construct at least one ray by taking a point in the ray emission region as a ray starting point and taking a direction opposite to the normal direction of the sampled texel as a ray direction, and determine texels in the initial three-dimensional mesh model that intersect any one of the at least one ray, to obtain at least one candidate texel;
a judgment module 1106, configured to determine, if at least one spatially adjacent texel of the sampled texel exists in the at least one candidate texel, the sampled texel as a first seam texel;
the determination module 1104 being further configured to determine, from the at least one spatially adjacent texel, a second seam texel having a seam adjacency relationship with the first seam texel; and
a repair module 1108, configured to repair the first seam texel and the second seam texel in the initial three-dimensional mesh model, to obtain a target three-dimensional mesh model after seam repair.

In an embodiment, the construction module 1102 is further configured to, for each of the texels in the initial three-dimensional mesh model, ignore, in the three-dimensional virtual scene, the texel if an occlusion mesh patch exists within a preset range along a normal direction of the texel from the texel; the occlusion mesh patch being a mesh patch in the initial three-dimensional mesh model other than a mesh patch where the texel is located; and take the texels not ignored in the initial three-dimensional mesh model as the sampled texels.

In an embodiment, the determination module 1104 is further configured to determine the texels in the initial three-dimensional mesh model that intersect any one of the at least one ray, to obtain intersecting texels; and for each of the intersecting texels, take the intersecting texel as a candidate texel if coordinates of the intersecting texel in a planar mesh model are discontinuous with coordinates of the sampled texel in the planar mesh model or the intersecting texel and the sampled texel are located in different initial three-dimensional mesh models; where the planar mesh model is a mesh model after two-dimensional flattening on the initial three-dimensional mesh model.

In an embodiment, the judgment module 1106 is further configured to, for each of the at least one candidate texel, determine the candidate texel as a spatially adjacent texel of the sampled texel if a first mesh patch corresponding to the candidate texel and a second mesh patch corresponding to the sampled texel are continuous in the three-dimensional virtual scene; where the first mesh patch is a mesh patch where the candidate texel is located in the initial three-dimensional mesh model; and the second mesh patch is a mesh patch where the sampled texel is located in the initial three-dimensional mesh model.

In an embodiment, the determination module 1104 is further configured to select, from the at least one spatially adjacent texel according to at least one of an illumination difference between illumination data of the spatially adjacent texel and illumination data of the first seam texel, a plane difference between a mesh patch where the spatially adjacent texel is located and a mesh patch where the first seam texel is located, a spatial distance between the spatially adjacent texel and the first seam texel in the three-dimensional virtual scene, and an intersection area between a coverage region of the spatially adjacent texel in the initial three-dimensional mesh model and a coverage region of the first seam texel in the initial three-dimensional mesh model, the spatially adjacent texel meeting a target condition; and determine the second seam texel from the selected spatially adjacent texel.

In an embodiment, the determination module 1104 is further configured to, in a case that the at least one spatially adjacent texel is screened according to the illumination difference between the illumination data of the spatially adjacent texel and the illumination data of the first seam texel, for each of the at least one spatially adjacent texel, determine a normal angle between the mesh patches corresponding to the spatially adjacent texel and the first seam texel, to obtain a first angle corresponding to the spatially adjacent texel; the first angle being positively correlated with the illumination difference; and select, from the at least one spatially adjacent texel, the spatially adjacent texel with the first angle less than or equal to a preset angle.

In an embodiment, the determination module 1104 is further configured to, in a case that the at least one spatially adjacent texel is screened according to the plane difference between the mesh patch where the spatially adjacent texel is located and the mesh patch where the first seam texel is located, select, from the at least one spatially adjacent texel, a spatially adjacent texel having a patch coplanarity relationship with the first seam texel; where a mesh patch corresponding to the selected spatially adjacent texel and the mesh patch corresponding to the first seam texel are on the same plane.

In an embodiment, the determination module 1104 is further configured to, in a case that the at least one spatially adjacent texel is screened according to the spatial distance between the spatially adjacent texel and the first seam texel in the three-dimensional virtual scene, select, from the at least one spatially adjacent texel, the spatially adjacent texel with the spatial distance less than or equal to a preset distance; where the preset distance is less than or equal to a texel radius of the first seam texel.

In an embodiment, the determination module 1104 is further configured to, in a case that the at least one spatially adjacent texel is screened according to the intersection area between the coverage region of the spatially adjacent texel in the initial three-dimensional mesh model and the coverage region of the first seam texel in the initial three-dimensional mesh model, for each of the at least one spatially adjacent texel, determine an angle between a texel vector and a reverse edge normal vector corresponding to the first seam texel, to obtain a second angle corresponding to the spatially adjacent texel; the texel vector being a vector pointing from the first seam texel to the spatially adjacent texel; the reverse edge normal vector being opposite to a direction of an edge normal of the first seam texel; and select, from the at least one spatially adjacent texel, the spatially adjacent texel with a minimum second angle; where a size of the second angle is negatively correlated with a size of the intersection area.

In an embodiment, the initial three-dimensional mesh model has a corresponding initial illumination map; and the repair module 1108 is further configured to determine, from the initial illumination map, a texel mapped to each of the first seam texel and the second seam texel as a to-be-repaired seam texel; determine, for each of the to-be-repaired seam texels, a denoising reference region corresponding to the to-be-repaired seam texel in the initial illumination map according to the to-be-repaired seam texel and a seam texel having the seam adjacency relationship with the to-be-repaired seam texel in the initial illumination map; determine, according to an angle between an edge normal of each reference texel in the denoising reference region and an edge normal of the to-be-repaired seam texel, an illumination contribution parameter corresponding to the reference texel; denoise and repair, according to the illumination contribution parameters corresponding to the reference texels and illumination data recorded for the reference texels in the initial illumination map, illumination data recorded for the to-be-repaired seam texel in the initial illumination map, to obtain a target illumination map; and perform illumination rendering on the initial three-dimensional mesh model according to the target illumination map, to obtain the target three-dimensional mesh model after seam repair on the initial three-dimensional mesh model.

In an embodiment, the repair module 1108 is further configured to determine, along a direction of the edge normal of the to-be-repaired seam texel, a first sampling range of a filter kernel configured for denoising and repairing; determine, along a direction of an edge normal of an adjacent seam texel, a second sampling range of the filter kernel; the adjacent seam texel being a seam texel having the seam adjacency relationship with the to-be-repaired seam texel; and determine the denoising reference region corresponding to the to-be-repaired seam texel in the initial illumination map according to the first sampling range and the second sampling range.

In an embodiment, the repair module 1108 is further configured to denoise and repair, according to the illumination contribution parameters corresponding to the reference texels and the illumination data recorded for the reference texels in the initial illumination map, the illumination data recorded for the to-be-repaired seam texel in the initial illumination map, to obtain denoised illumination data corresponding to the to-be-repaired seam texel; blend the denoised illumination data corresponding to the to-be-repaired seam texel with illumination data before denoising, to obtain blended illumination data corresponding to the to-be-repaired seam texel; and write the blended illumination data respectively corresponding to the to-be-repaired seam texels back to the initial illumination map, to obtain the target illumination map.

In an embodiment, the repair module 1108 is further configured to write the blended illumination data respectively corresponding to the to-be-repaired seam texels back to the initial illumination map, to obtain a blended illumination map; determine, along a direction of the edge normal of the to-be-repaired seam texel, a secondary texel adjacent to the to-be-repaired seam texel from the blended illumination map; and blending illumination data recorded for the secondary texel in the blended illumination map with illumination data recorded for an adjacent seam texel in the blended illumination map, to obtain the target illumination map; the adjacent seam texel being a seam texel having the seam adjacency relationship with the to-be-repaired seam texel.

In an embodiment, the repair module 1108 is further configured to denoise and repair, according to the illumination contribution parameters corresponding to the reference texels and the illumination data recorded for the reference texels in the initial illumination map, the illumination data recorded for the to-be-repaired seam texel in the initial illumination map, to obtain a denoised illumination map; for each of the to-be-repaired seam texels, determine, from the denoised illumination map, an unmapped texel adjacent to the to-be-repaired seam texel and having no illumination data recorded therefor; and fill the unmapped texel with illumination data recorded for an adjacent seam texel in the denoised illumination map, to obtain the target illumination map; the adjacent seam texel being a seam texel having the seam adjacency relationship with the to-be-repaired seam texel.

In an embodiment, the repair module 1108 is further configured to, for each reference texel in the denoising reference region, determine a first normal influence parameter according to the angle between the edge normal of the reference texel and the edge normal of the to-be-repaired seam texel; and determine the illumination contribution parameter corresponding to the reference texel according to at least one of the first normal influence parameter, a second normal influence parameter, a distance influence parameter, and a brightness influence parameter; where the second normal influence parameter is configured for representing a degree of influence of a normal of the to-be-repaired seam texel in the three-dimensional virtual scene and a normal of the reference texel in the three-dimensional virtual scene on the illumination contribution; the distance influence parameter is configured for representing a degree of influence of a distance between the to-be-repaired seam texel and the reference texel in the three-dimensional virtual scene on the illumination contribution; and the brightness influence parameter is configured for representing a degree of influence of brightness of the to-be-repaired seam texel and brightness of the reference texel on the illumination contribution.

In the above model seam repairing apparatus, for each sampled texel in an initial three-dimensional mesh model in a three-dimensional virtual scene, a ray emission region perpendicular to a normal direction of the sampled texel is constructed, at least one ray is constructed by taking a point in the ray emission region as a ray starting point and taking a direction opposite to the normal direction of the sampled texel as a ray direction, and texels in the initial three-dimensional mesh model that intersect any one of the at least one ray are determined, to obtain at least one candidate texel. If at least one spatially adjacent texel of the sampled texel exists in the at least one candidate texel, the sampled texel is determined as a first seam texel. A second seam texel having a seam adjacency relationship with the first seam texel may be quickly determined from the at least one spatially adjacent texel. Then, the first seam texel and the second seam texel in the initial three-dimensional mesh model are repaired, to obtain a target three-dimensional mesh model after seam repair. Compared with the related manner of traversing model vertices one by one to search for seam texels, in the seam searching manner in this disclosure, there is no need to traverse model vertices to search for seam texels; instead, the seam texels are searched for by constructing a ray emission region and generating rays by the ray emission region to intersect with the initial three-dimensional mesh model, which improves search efficiency of the seam texels of the model. Then, the first seam texel and the second seam texel quickly found are repaired, which can improve seam repair efficiency of the model.

All or some of the modules in the foregoing model seam repairing apparatus may be implemented by using software, hardware, or a combination thereof. The modules may be built in or stand alone from a processor in a computer device in a form of hardware, or may be stored in a memory in a computer device in a form of software, so that the processor can invoke and execute operations corresponding to the modules.

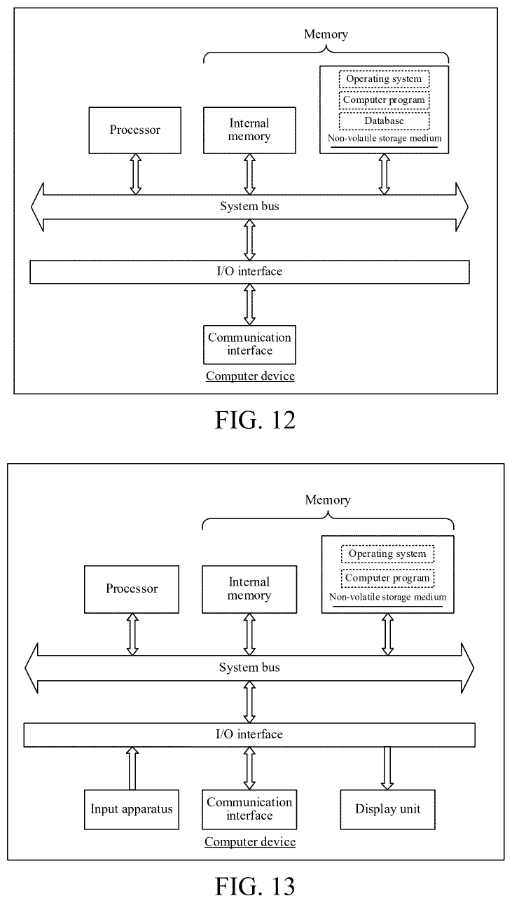

In an embodiment, a computer device is provided. The computer device may be a server, and an internal structure diagram thereof may be shown in FIG. 12. The computer device includes a processor, a memory, an input/output (I/O) interface, and a communication interface. The processor, the memory, and the I/O interface are connected to each other by using a system bus, and the communication interface is connected to the system bus by using the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for operation of the operating system and the computer program in the non-volatile storage medium. The I/O interface of the computer device is configured to exchange information between the processor and an external device. The communication interface of the computer device is configured to connect and communicate with an external terminal via a network. The computer program, when executed by the processor, implements the model seam repairing method described above.

In an embodiment, a computer device is provided. The computer device may be a terminal, and an internal structure thereof may be shown as FIG. 13. The computer device includes a processor, a memory, an I/O interface, a communication interface, a display unit, and an input apparatus. The processor, the memory, and the I/O interface are connected to each other by using a system bus, and the communication interface, the display unit, and the input apparatus are connected to the system bus by using the I/O interface. The processor of the computer device is configured to provide computing and control capabilities. The memory of the computer device includes a non-volatile storage medium and an internal memory. The non-volatile storage medium stores an operating system and a computer program. The internal memory provides an environment for operation of the operating system and the computer program in the non-volatile storage medium. The I/O interface of the computer device is configured to exchange information between the processor and an external device. The communication interface of the computer device is configured to communicate with an external terminal in a wired or wireless manner. The wireless manner may be implemented by WIFI, a mobile cellular network, near field communication (NFC), or another technology. The computer program, when executed by the processor, implements the model seam repairing method described above. The display unit of the computer device may be configured to form a visually visible screen and may be a display screen, a projection apparatus, or a VR imaging apparatus. The display screen may be a liquid crystal display screen or an e-ink display screen. The input apparatus of the computer device may be a touch layer covering the display screen, or may be a key, a trackball, or a touchpad disposed on a housing of the computer device, or may be an external keyboard, a touchpad, a mouse, or the like.

It is noted that the structures shown in FIG. 12 and FIG. 13 are merely examples of block diagrams of partial structures related to the solution in this disclosure, and do not constitute a limitation on the computer device to which the solution in this disclosure is applied. In some examples, the computer device may include more or fewer components than those shown in the figures, or have some components combined, or have a different component arrangement.

In an embodiment, a computer device is further provided, including: a memory and a processor, the memory stores a computer program, and the computer program is executed by the processor to perform the steps of the foregoing method embodiments.

In an embodiment, a computer-readable storage medium is provided, having a computer program stored therein, and the computer program is executed by a processor to perform the steps of the foregoing method embodiments.

In some embodiments, a computer program product is provided, including a computer program. When the computer program is executed by a processor, the steps in the foregoing method embodiments are implemented.

User information (including, but not limited to, user equipment information, user personal information, and the like) and data (including, but not limited to, data for analysis, stored data, displayed data, and the like) involved in this disclosure are all information and data authorized by users or fully authorized by all parties, and collection, use, and processing of relevant data need to comply with relevant laws, regulations, and standards of relevant countries and regions.

It is noted that all or some of procedures of the method in the foregoing embodiments may be implemented by a computer program instructing relevant hardware. The computer program may be stored in a non-volatile computer-readable storage medium. When the computer program is executed, the procedures of the foregoing method embodiments may be implemented. Any reference to a memory, a storage, a database, or another medium used in the embodiments provided in this disclosure may include at least one of a non-volatile memory and a volatile memory. The non-volatile memory may include a read-only memory (ROM), a magnetic tape, a floppy disk, a flash memory, or an optical memory. The volatile memory may include a random-access memory (RAM) or an external cache. For the purpose of illustration but not limitation, the RAM is available in many forms, for example, a static random access memory (SRAM) or a dynamic random access memory (DRAM).

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Technical features of the foregoing embodiments may be combined in various manners. To make the description concise, not all possible combinations of the technical features in the foregoing embodiments are described. However, the combinations of these technical features shall be considered as falling within the scope recorded by this specification provided that no conflict exists.

The foregoing embodiments only describe several implementations of this disclosure, which are described in detail, but cannot be construed as a limitation on the patent scope of the present disclosure. It is noted that several transformations and improvements can be made without departing from the idea of this disclosure, all of which fall within the protection scope of this disclosure.

What is claimed is:

1. A method of model seam repairing, the method comprising:
constructing a ray emission region perpendicular to a normal direction of a sampled texel in a first mesh patch of a first initial three-dimensional mesh model in a three-dimensional virtual scene, the three-dimensional virtual scene comprising one or more initial three-dimensional mesh models including the first initial three-dimensional mesh model;
constructing one or more rays that start in the ray emission region and extend in an opposite direction of the normal direction of the sampled texel;
determining one or more candidate texels in the one or more initial three-dimensional mesh models, the one or more candidate texels respectively intersecting with at least a ray in the one or more rays;
determining, when the one or more candidate texels include at least one spatially adjacent texel of the sampled texel, the sampled texel as a first seam texel;
determining, from the at least one spatially adjacent texel, a second seam texel that has a seam adjacency relationship with the first seam texel; and
performing at least a seam repair of the first seam texel and the second seam texel to obtain a target three-dimensional mesh model.

2. The method according to claim 1, further comprising:
for a texel in the first initial three-dimensional mesh model, ignoring, the texel for processing as the sampled texel when an occlusion mesh patch exists within a preset range along a normal direction of the texel, wherein
the occlusion mesh patch is a different mesh patch in the one or more initial three-dimensional mesh models other than a mesh patch where the texel is located.

3. The method according to claim 1, wherein
the determining the one or more candidate texels comprises:
obtaining a plurality of intersecting texels of the three-dimensional virtual scene that intersect the one or more rays; and
taking an intersecting texel in the plurality of intersecting texels as a candidate texel in the one or more candidate texels when first coordinates of the intersecting texel in a planar mesh model are discontinuous with second coordinates of the sampled texel in the planar mesh model or the intersecting texel is located in a different initial three-dimensional mesh model in the one or more initial three-dimensional mesh models from the first initial three-dimensional mesh model; and
the planar mesh model is a two-dimensional flattening mesh model of the one or more initial three-dimensional mesh models.

4. The method according to claim 3, further comprising:
determining that a candidate texel in the one or more candidate texels is a spatially adjacent texel of the sampled texel in the at least one spatially adjacent texel of the sampled texel when a second mesh patch that includes the candidate texel and the first mesh patch that includes the sampled texel are continuous in the three-dimensional virtual scene.

5. The method according to claim 1, wherein the determining the second seam texel comprises:
selecting, from the at least one spatially adjacent texel, the second seam texel that meets a target condition according to a continuous measure, the continuous measure including at least one of an illumination difference between the second seam texel and the first seam texel, a plane difference of a second mesh patch that includes the second seam texel and the first mesh patch that includes the first seam texel, a spatial distance between the second seam texel and the first seam texel in the three-dimensional virtual scene, and an intersection area of a coverage region of the second seam texel in the first initial three-dimensional mesh model and a coverage region of the first seam texel in the first initial three-dimensional mesh model.

6. The method according to claim 5, wherein the selecting comprises:
determining, respective first angles of the at least one spatially adjacent texel, a first angle of a spatially adjacent texel in the at least one spatially adjacent texel being a normal angle between the first mesh patch that includes the first seam texel and another mesh patch that includes the spatially adjacent texel, the first angle of the spatially adjacent texel being positively correlated with an illumination difference of the spatially adjacent texel to the first seam texel; and
selecting, from the at least one spatially adjacent texel, the second seam texel according to comparisons of the respective first angles of the at least one spatially adjacent texel to a preset angle.

7. The method according to claim 5, wherein the selecting comprises:
selecting, from the at least one spatially adjacent texel, the second seam texel when the second mesh patch and the first mesh patch are on a same plane.

8. The method according to claim 5, wherein the selecting comprises:
selecting, from the at least one spatially adjacent texel, the second seam texel with the spatial distance less than or equal to a preset distance, and the preset distance being less than or equal to a texel radius of the first seam texel.

9. The method according to claim 5, wherein the selecting comprises:
determining respective second angles of the at least one spatially adjacent texel, a second angle of a spatially adjacent texel in the at least one spatially adjacent texel being an angle between a texel vector of the spatially adjacent texel and a reverse edge normal vector of the first seam texel, the texel vector being a vector pointing from the first seam texel to the spatially adjacent texel, the reverse edge normal vector being opposite to a direction of an edge normal of the first seam texel, the second angle of the spatially adjacent texel being negatively correlated to a size of an intersection area of the spatially adjacent texel and the first seam texel; and
selecting, from the at least one spatially adjacent texel, the second seam texel that has a minimum second angle among the respective second angles.

10. The method according to claim 1, wherein the first initial three-dimensional mesh model has an initial illumination map, and the repairing comprises:
determining, from the initial illumination map, to-be-repaired seam texels that are respectively mapped to the first seam texel and the second seam texel;
determining, respective denoising reference regions of the to-be-repaired seam texels in the initial illumination map, a denoise reference region of a to-be-repaired seam texel in the to-be-repaired seam texels being determined according to the to-be-repaired seam texel and a seam texel having the seam adjacency relationship with the to-be-repaired seam texel in the initial illumination map;
determining, respective illumination contribution parameters of reference texels in the respective denoising reference regions, an illumination contribution parameter of a reference texel in a denoising reference region of a to-be-repaired seam texel in the to-be-repaired seam texels being determined according to an angle between an edge normal of the reference texel in the denoising reference region and an edge normal of the to-be-repaired seam texel;
denoising and repairing, according to the respective illumination contribution parameters of the reference texels and illumination data recorded for the reference texels in the initial illumination map, first illumination data recorded for the to-be-repaired seam texels in the initial illumination map, to obtain a target illumination map; and
performing illumination rendering on the first initial three-dimensional mesh model according to the target illumination map, to obtain the target three-dimensional mesh model.

11. The method according to claim 10, wherein the determining the respective denoising reference regions comprises:
determining, along a direction of the edge normal of the to-be-repaired seam texel, a first sampling range of a filter kernel;
determining, along a direction of an edge normal of an adjacent seam texel, a second sampling range of the filter kernel, the adjacent seam texel being a seam texel having the seam adjacency relationship with the to-be-repaired seam texel; and
determining the denoising reference region of the to-be-repaired seam texel in the initial illumination map according to the first sampling range and the second sampling range.

12. The method according to claim 10, wherein the denoising and the repairing comprises:
denoising and repairing, according to the respective illumination contribution parameters of the reference texels and the illumination data recorded for the reference texels in the initial illumination map, the first illumination data recorded for the to-be-repaired seam texels in the initial illumination map, to obtain denoised illumination data of the to-be-repaired seam texels;
blending the denoised illumination data of the to-be-repaired seam texels with the first illumination data before denoising, to obtain blended illumination data of the to-be-repaired seam texels; and
updating the initial illumination map with the blended illumination data of the to-be-repaired seam texels to obtain the target illumination map.

13. The method according to claim 12, wherein the updating comprises:
writing the blended illumination data of the to-be-repaired seam texels back to the initial illumination map, to obtain a blended illumination map;
determining, secondary texels respectively adjacent to the to-be-repaired seam texels in the blended illumination map, a secondary texel adjacent to a to-be-repaired seam texel being determined along a direction of an edge normal of the to-be-repaired seam texel; and
blending second illumination data recorded for the secondary texels in the blended illumination map with third illumination data recorded for respective adjacent seam texels of the to-be-repaired seam texels in the blended illumination map, to obtain the target illumination map, a adjacent seam texel of a to-be-repaired seam texel being a seam texel having the seam adjacency relationship with the to-be-repaired seam texel.

14. The method according to claim 10, wherein the denoising and the repairing comprises:
denoising and repairing, according to the respective illumination contribution parameters of the reference texels and the illumination data recorded for the reference texels in the initial illumination map, the first illumination data recorded for the to-be-repaired seam texels in the initial illumination map, to obtain a denoised illumination map;
determining, from the denoised illumination map, at least an unmapped texel adjacent to a to-be-repaired seam texel of the to-be-repaired seam texels, the unmapped texel having no illumination data recorded in the denoised illumination map; and
filling the unmapped texel with illumination data recorded for an adjacent seam texel in the denoised illumination map, to obtain the target illumination map, the adjacent seam texel being a seam texel having the seam adjacency relationship with the to-be-repaired seam texel.

15. The method according to claim 10, wherein:
the determining the respective illumination contribution parameters of the reference texels comprises:
determining a first normal influence parameter according to the angle between the edge normal of the reference texel and the edge normal of the to-be-repaired seam texel; and
determining the illumination contribution parameter of the reference texel according to at least one of the first normal influence parameter, a second normal influence parameter, a distance influence parameter, and a brightness influence parameter;
the second normal influence parameter represents a degree of illumination contribution influence by a normal of the to-be-repaired seam texel in the three-dimensional virtual scene and a normal of the reference texel in the three-dimensional virtual scene;
the distance influence parameter represents a degree of illumination contribution influence by a distance between the to-be-repaired seam texel and the reference texel; and
the brightness influence parameter represents a degree of illumination contribution influence by a brightness of the to-be-repaired seam texel and a brightness of the reference texel.

16. An image processing apparatus, comprising processing circuitry configured to:
construct a ray emission region perpendicular to a normal direction of a sampled texel in a first mesh patch of a first initial three-dimensional mesh model in a three-dimensional virtual scene, the three-dimensional virtual scene comprising one or more initial three-dimensional mesh models including the first initial three-dimensional mesh model;
construct one or more rays that start in the ray emission region and extend in an opposite direction of the normal direction of the sampled texel;
determine one or more candidate texels in the one or more initial three-dimensional mesh models, the one or more candidate texels respectively intersecting with at least a ray in the one or more rays;
determine, when the one or more candidate texels include at least one spatially adjacent texel of the sampled texel, the sampled texel as a first seam texel;
determine, from the at least one spatially adjacent texel, a second seam texel that has a seam adjacency relationship with the first seam texel; and
perform at least a seam repair of the first seam texel and the second seam texel to obtain a target three-dimensional mesh model.

17. The image processing apparatus according to claim 16, wherein the processing circuitry is configured to:
for a texel in the first initial three-dimensional mesh model, ignore, the texel for processing as the sampled texel when an occlusion mesh patch exists within a preset range along a normal direction of the texel, the occlusion mesh patch being a different mesh patch in the one or more initial three-dimensional mesh models other than a mesh patch where the texel is located.

18. The image processing apparatus according to claim 16, wherein
the processing circuitry is configured to:
obtain a plurality of intersecting texels of the three-dimensional virtual scene that intersect the one or more rays; and
take an intersecting texel in the plurality of intersecting texels as a candidate texel in the one or more candidate texels when first coordinates of the intersecting texel in a planar mesh model are discontinuous with second coordinates of the sampled texel in the planar mesh model or the intersecting texel is located in a different initial three-dimensional mesh model in the one or more initial three-dimensional mesh models from the first initial three-dimensional mesh model; and
the planar mesh model is a two-dimensional flattening mesh model of the one or more initial three-dimensional mesh models.

19. The image processing apparatus according to claim 18, wherein the processing circuitry is configured to:
determine that a candidate texel in the one or more candidate texels is a spatially adjacent texel of the sampled texel in the at least one spatially adjacent texel of the sampled texel when a second mesh patch that includes the candidate texel and the first mesh patch that includes the sampled texel are continuous in the three-dimensional virtual scene.

20. A non-transitory computer-readable storage medium storing instructions which when executed by at least one processor cause the at least one processor to perform:
constructing a ray emission region perpendicular to a normal direction of a sampled texel in a first mesh patch of a first initial three-dimensional mesh model in a three-dimensional virtual scene, the three-dimensional virtual scene comprising one or more initial three-dimensional mesh models including the first initial three-dimensional mesh model;
constructing one or more rays that start in the ray emission region and extend in an opposite direction of the normal direction of the sampled texel;
determining one or more candidate texels in the one or more initial three-dimensional mesh models, the one or more candidate texels respectively intersecting with at least a ray in the one or more rays;
determining, when the one or more candidate texels include at least one spatially adjacent texel of the sampled texel, the sampled texel as a first seam texel;
determining, from the at least one spatially adjacent texel, a second seam texel that has a seam adjacency relationship with the first seam texel; and
performing at least a seam repair of the first seam texel and the second seam texel to obtain a target three-dimensional mesh model.
